(19) United States
(12) Patent Application Publication
(10) Pub. No.: US 2023/0239501 A1
(43) Pub. Date: Jul. 27, 2023

(54) POINT CLOUD DATA TRANSMISSION DEVICE, POINT CLOUD DATA TRANSMISSION METHOD, POINT CLOUD DATA RECEPTION DEVICE, AND POINT CLOUD DATA RECEPTION METHOD

(71) Applicant: LG ELECTRONICS INC., Seoul (KR)

(72) Inventors: Hyunmook OH, Seoul (KR); Sejin OH, Seoul (KR)

(21) Appl. No.: 18/008,007

(22) PCT Filed: Jun. 7, 2021
(86) PCT No.: PCT/KR2021/007094

§ 371 Date: Dec. 2, 2022

(30) Foreign Application Priority Data
Jun. 5, 2020 (KR) 10-2020-0068424

(51) Int. Cl. H04N 19/597; H04N 19/119; G06T 17/00; H04N 19/136; H04N 19/96

(52) U.S. Cl. CPC H04N 19/597; G06T 17/00; H04N 19/96; H04N 19/119; H04N 19/136; G06T 2210/56

(57) ABSTRACT

A point cloud data transmission method according to embodiments comprises the steps of: encoding point cloud data; and transmitting signaling data and the encoded point cloud data, wherein the step for encoding may comprise the steps of: dividing the point cloud data into a plurality of compression units; sorting, for each compression unit, the point cloud data in each compression unit; generating a prediction tree on the basis of the sorted point cloud data in the compression units; and compressing the point cloud data in the compression units by predicting on the basis of the prediction tree.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space (or volume). The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud

Another object of the present disclosure is to provide a point cloud data transmission device, a point cloud data transmission method, a point cloud data reception device, and a point cloud data reception method for addressing latency and encoding/decoding complexity

Another object of the present disclosure is to provide a point cloud data transmission device, a point cloud data transmission method, a point cloud data reception device, and a point cloud data reception method for efficiently transmitting and receiving a geometry-point cloud compression (G-PCC) bitstream.

Another object of the present disclosure is to provide a point cloud data transmission device, a point cloud data transmission method, a point cloud data reception device, and a point cloud data reception method for efficiently compressing point cloud data the point cloud data by compressing and transmitting/receiving the point cloud data by applying a prediction-based coding technique.

Another object of the present disclosure is to provide a point cloud data transmission device and point cloud data transmission method suitable for low latency applications by using a predictive tree structure for both geometry coding and attribute coding of point cloud data.

Another object of the present disclosure is to provide a point cloud data reception device and point cloud data reception method suitable for low latency applications by using a predictive tree structure for both geometry decoding and attribute decoding of point cloud data.

Objects of the present disclosure are not limited to the aforementioned objects, and other objects of the present disclosure which are not mentioned above will become apparent to those having ordinary skill in the art upon examination of the following description.

### Technical Solution

The above objects and other objects of the present disclosure can be achieved by providing a method of transmitting point cloud data. The method may include encoding point cloud data, and transmitting the encoded point cloud data and signaling data.

In an embodiment, the encoding may include dividing the point cloud data into a plurality of compression units, sorting the point cloud data in each of the compression units according to the compression units, generating a predictive tree based on the sorted point cloud data in each of the compression units, and compressing the point cloud data in the compression units by performing prediction based on the predictive tree.

In an embodiment, the dividing may include clustering the point cloud data based on at least one of similarity of geometry information or similarity of attribute information related to points of the point cloud data, and dividing points of the point cloud data into the plurality of compression units.

In an embodiment, the sorting may include sorting points of the point cloud data in each of the compression units based on at least one of similarity of geometry information or similarity of attribute information related to the points of the point cloud data in each of the compression units.

In an embodiment, the generating of the predictive tree may include generating the predictive tree based on at least one of similarity of geometry information or similarity of attribute information related to points of the sorted point cloud data in each of the compression units.

In an embodiment, the compressing may include predicting the geometry information and the attribute information related to the point cloud data based on the predictive tree and generating residual information related to the geometry information and residual information related to the attribute information, wherein different weights may be assigned to the residual information related to the geometry information and the residual information related to the attribute information.

In an embodiment, in the predicting of the geometry information and attribute information related to the point cloud data based on the predictive tree, the compressing may apply the same predictive coding parameter to the geometry information and the attribute information.

In an embodiment, in the predicting of the geometry information and attribute information related to the point cloud data based on the predictive tree, the compressing may apply different predictive coding parameters to the geometry information and the attribute information.

A device for transmitting point cloud data according to embodiments may include an encoder configured to encode point cloud data, and a transmitter configured to transmit the encoded point cloud data and signaling data.

In an embodiment, the encoder may include a divider configured to divide the point cloud data into a plurality of compression units, a sorter configured to sort the point cloud data in each of the compression units according to the compression units, a predictive tree generator configured to generate a predictive tree based on the sorted point cloud data in each of the compression units, and a compressor configured to compress the point cloud data in the compression units by performing prediction based on the predictive tree.

In an embodiment, the divider may be configured to cluster the point cloud data based on at least one of similarity of geometry information or similarity of attribute information related to points of the point cloud data to divide the points of the point cloud data into the compression units, and divide points of the point cloud data into the plurality of compression units.

In an embodiment, the sorter may sort points of the point cloud data in each of the compression units based on at least one of similarity of geometry information or similarity of attribute information related to the points of the point cloud data in each of the compression units.

In an embodiment, the predictive tree generator may generate the predictive tree based on at least one of similarity of geometry information or similarity of attribute information related to points of the sorted point cloud data in each of the compression units.

In an embodiment, the compressor may predict the geometry information and the attribute information related to the point cloud data based on the predictive tree and generate residual information related to the geometry information and residual information related to the attribute information, wherein different weights may be assigned to the residual information related to the geometry information and the residual information related to the attribute information.

In an embodiment, in predicting the geometry information and attribute information related to the point cloud data based on the predictive tree, the compressor may apply the same predictive coding parameter to the geometry information and the attribute information.

In an embodiment, in predicting the geometry information and attribute information related to the point cloud data based on the predictive tree, the compressor may apply different predictive coding parameters to the geometry information and the attribute information.

A method of receiving point cloud data according to embodiments may include receiving point cloud data and signaling data, decoding the point cloud data based on the signaling data, and rendering the decoded point cloud data based on the signaling data.

In an embodiment, the decoding may include generating a predictive tree in a compression unit based on the signaling data, and reconstructing the point cloud data in the compression unit by performing prediction based on the predictive tree.

In an embodiment, the reconstructing may include performing the prediction by applying the predictive tree and the same predictive coding parameter to geometry information and attribute information related to the point cloud data, and reconstructing the geometry information and the attribute information.

In an embodiment, the reconstructing may include performing the prediction by applying the predictive tree and different predictive coding parameters to geometry information and attribute information related to the point cloud data, and reconstructing the geometry information and the attribute information.

A device for receiving point cloud data according to embodiments may include a receiver configured to receive point cloud data and signaling data, a decoder configured to decode the point cloud data based on the signaling data, and a renderer configured to render the decoded point cloud data based on the signaling data.

In an embodiment, the decoder may include a predictive tree generator configured to generate a predictive tree in a compression unit based on the signaling data, and a reconstructor configured to reconstruct the point cloud data in the compression unit by performing prediction based on the predictive tree.

In an embodiment, the reconstructor may be configured to perform the prediction by applying the predictive tree and the same predictive coding parameter to geometry information and attribute information related to the point cloud data and reconstruct the geometry information and the attribute information.

In an embodiment, the reconstructor may be configured to perform the prediction by applying the predictive tree and different predictive coding parameters to geometry information and attribute information related to the point cloud data and reconstruct the geometry information and the attribute information.

### Advantageous Effects

A point cloud data transmission method, a point cloud data transmission device, a point cloud data reception method, and a point cloud data reception device according to embodiments may provide a good-quality point cloud service.

A point cloud data transmission method, a point cloud data transmission device, a point cloud data reception method, and a point cloud data reception device according to embodiments may achieve various video codec methods.

A point cloud data transmission method, a point cloud data transmission device, a point cloud data reception method, and a point cloud data reception device according to embodiments may provide universal point cloud content such as a self-driving service (or an autonomous driving service).

A point cloud data transmission method, a point cloud data transmission device, a point cloud data reception method, and a point cloud data reception device according to embodiments may perform space-adaptive partition of point cloud data for independent encoding and decoding of the point cloud data, thereby improving parallel processing and providing scalability.

A point cloud data transmission method, a point cloud data transmission device, a point cloud data reception method, and a point cloud data reception device according to embodiments may perform encoding and decoding by partitioning the point cloud data in units of tiles and/or slices, and signal necessary data therefore, thereby improving encoding and decoding performance of the point cloud.

A point cloud data transmission method, a point cloud data transmission device, a point cloud data reception method, and a point cloud data reception device according to embodiments may use a prediction-based point cloud compression technique, thereby providing fast encoding and decoding for an environment requiring low delay (or low latency).

A point cloud data transmission method, a point cloud data transmission device, a point cloud data reception method, and a point cloud data reception device according to embodiments may simultaneously compress geometry and attributes for each point, thereby dramatically reducing the execution time required to separately use the geometry and attribute compression. In particular, the encoding time may be shortened by using a single predictive tree structure for both geometry compression and attribute compression. In addition, as both geometry and attributes are considered in constructing a predictive tree, compression efficiency may be increased. Further, scalability may be adjusted on a point-by-point basis for a scalable coding application field that uses only a portion of information.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of point cloud content for each LOD according to embodiments.

FIG. 9 illustrates an example of point configuration of point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operable in connection with point cloud data methods/devices according to embodiments.

FIG. 15 is a flowchart illustrating a process of encoding point cloud data based on a predictive tree according to embodiments.

FIG. 16 is a diagram illustrating an example of obtaining a cluster according to embodiments.

FIG. 17-(a) and FIG. 17-(b) are diagrams illustrating examples of predictive tree configuration according to embodiments.

FIG. 18 illustrates an example of a predictive tree structure generated in consideration of geometry and/or attributes according to embodiments.

FIG. 19 illustrates an example of a bitstream structure of point cloud data for transmission/reception according to embodiments.

FIG. 20 illustrates another example of a bitstream structure of point cloud data for transmission/reception according to embodiments.

FIG. 21 shows an exemplary syntax structure of a sequence parameter set according to embodiments.

FIG. 22 shows another exemplary syntax structure of a sequence parameter set according to embodiments.

FIG. 23 shows an exemplary syntax structure of predictive_coding_method() according to embodiments.

FIG. 24 shows an exemplary syntax structure of a geometry parameter set according to embodiments.

FIG. 25 shows an exemplary syntax structure of an attribute parameter set according to embodiments.

FIG. 26 shows an exemplary syntax structure of a geometry slice bitstream according to embodiments.

FIG. 27 shows an exemplary syntax structure of a geometry slice header according to embodiments.

FIG. 28 shows an exemplary syntax structure of geometry slice data according to embodiments.

FIG. 29 shows an exemplary syntax structure of an attribute slice bitstream according to embodiments.

FIG. 30 shows an exemplary syntax structure of an attribute slice header according to embodiments.

FIG. 31 shows an exemplary syntax structure of attribute slice data according to embodiments.

FIG. 32 shows an exemplary syntax structure of a geometry-attribute slice bitstream according to embodiments.

FIG. 33 shows an exemplary syntax structure of a geometry-attribute slice header according to embodiments.

FIG. 34 shows an exemplary syntax structure of geometry-attribute slice data according to embodiments.

FIG. 35 is a diagram illustrating another example of a point cloud transmission device according to embodiments.

FIG. 36 is an exemplary detailed block diagram illustrating a point cloud video encoder according to embodiments.

FIG. 37 is a flowchart illustrating an example of a point cloud video encoding method according to embodiments.

FIG. 38 is a diagram illustrating another example of a point cloud reception device according to embodiments.

FIG. 39 is an exemplary detailed block diagram illustrating a point cloud video decoder according to embodiments.

FIG. 40 is a flowchart illustrating an example of a point cloud video decoding method according to embodiments.

FIG. 41 is a flowchart illustrating a point cloud data transmission method according to embodiments.

FIG. 42 is a flowchart illustrating a point cloud data reception method according to embodiments.

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present discloure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used herein have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

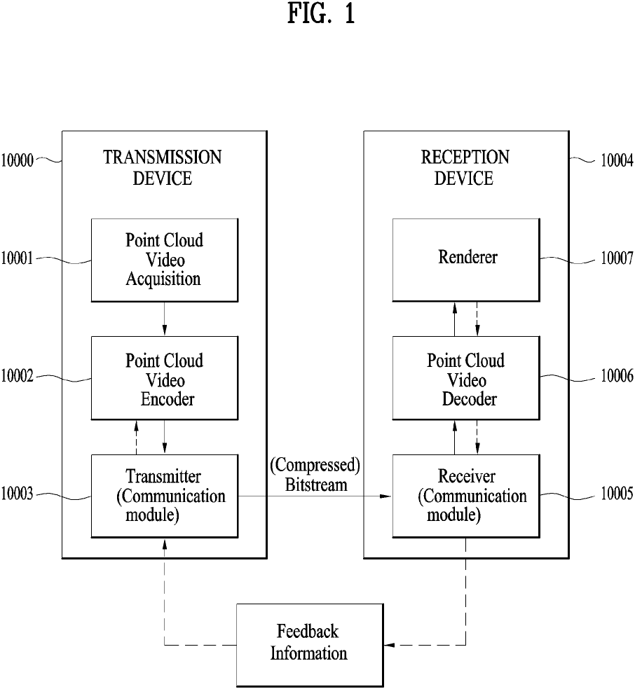

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. According to an emboidiment, the renderer 10007 may render the decoded point cloud data according to a viewport. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to the embodiments may represent information about a position, orientation, angle, and motion of a user’s head. The reception device 10004 according to the embodiments may calculate viewport information based on the head orientation information. The viewport information is information about a region of a point cloud video that the user is viewing (that is, a region that the user is currently viewing). That is, the viewport information is information about a region that the user is currently viewing in the point cloud video. In other words, the viewport or viewport region may represent a region that the user is viewing in the point cloud video. A viewpoint is a point that the user is viewing in the point cloud video, and may represent a center point of the viewport region. That is, the viewport is a region centered on a viewpoint, and the size and shape of the region may be determined by a field of view (FOV). Accordingly, the reception device 10004 may extract the viewport information based on a vertical or horizontal FOV supported by the device as well as the head orientation information. In addition, the reception device 10004 may perform gaze analysis or the like based on the head orientation information and/or the viewport information to determine the way the user consumes a point cloud video, a region that the user gazes at in the point cloud video, and the gaze time. According to embodiments, the reception device 10004 may transmit feedback information including the result of the gaze analysis to the transmission device 10000. According to embodiments, a device such as a VR/XR/AR/MR display may extract a viewport region based on the position/orientation of a user’s head and a vertical or horizontal FOV supported by the device. According to embodiments, the head orientation information and the viewport information may be referred to as feedback information, signaling information, or metadata.

The feedback information according to the embodiments may be acquired in the rendering and/or display process. The feedback information may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The feedback information may not only be transmitted to the transmitting side, but also be consumed by the receiving side. That is, the point cloud content providing system may process (encode/decode/render) point cloud data based on the feedback information. For example, the point cloud video decoder 10006 and the renderer 10007 may preferentially decode and render only the point cloud video for a region currently viewed by the user, based on the feedback information, that is, the head orientation information and/or the viewport information.

The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user’s head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

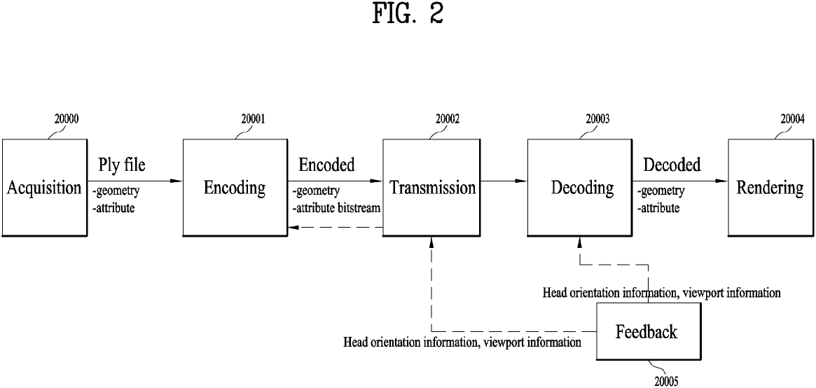

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC). The point cloud content providing system according to the embodiments (for example, the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like.

The point cloud content providing system (for example, the point cloud transmission device 10000 or the point cloud video acquisition unit 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

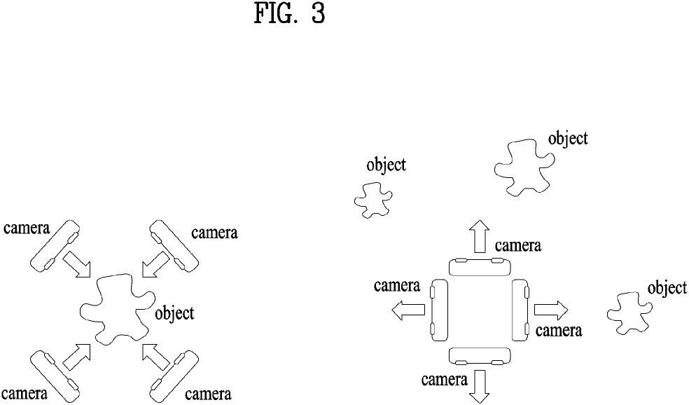

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user’s point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

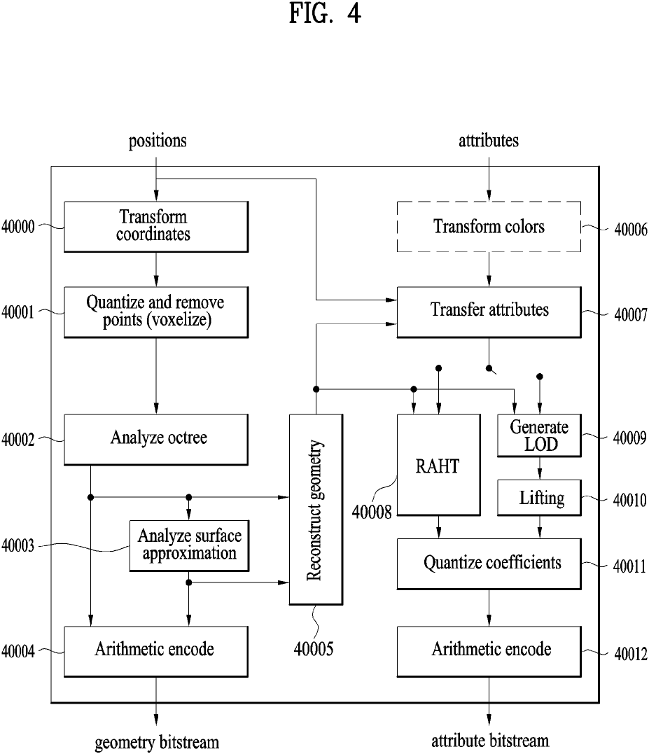

FIG. 4 illustrates an exemplary point cloud video encoder according to embodiments.

FIG. 4 shows an example of the point cloud video encoder 10002 of FIG. 1. The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud video encoder may perform geometry encoding and attribute encoding. The geometry encoding is performed before the attribute encoding.

The point cloud video encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry information. For example, the quantizer 40001 may quantize the points based on a minimum position value of all points (for example, a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

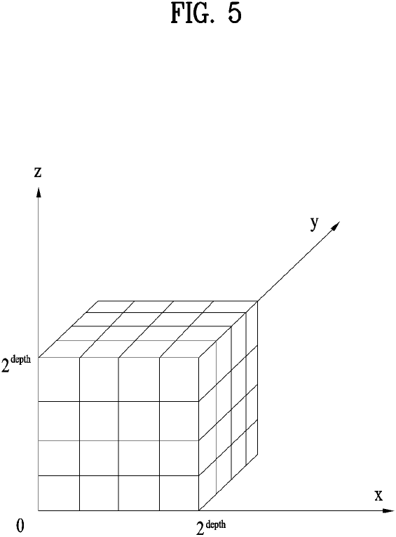

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

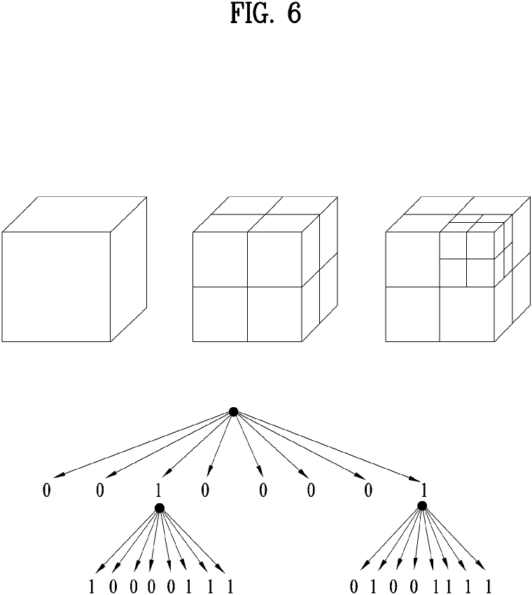

FIG. 6 shows an example of an octree and occupancy code according to embodiments.

As described with reference to FIGS. 1 to 4, the point cloud content providing system (point cloud video encoder 10002) or the octree analyzer 40002 of the point cloud video encoder performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

$$d = C e i l \left(L o g 2 \left(M a x \left({x}_{n}^{i n t} , {y}_{n}^{i \text{} n t} , {z}_{n}^{i n t} , n = 1 , … , N\right) + \text{} 1\right)\right)$$

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (for example, the arithmetic encoder 40004) according to the embodiments may perform entropy encoding on the occupancy codes. In order to increase the compression efficiency, the point cloud video encoder may perform intra/inter-coding on the occupancy codes. The reception device (for example, the reception device 10004 or the point cloud video decoder 10006) according to the embodiments reconstructs the octree based on the occupancy codes.

The point cloud video encoder (e.g., the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (for example, the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud video encoder according to the embodiments (for example, the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$\begin{matrix}1 \left[\begin{matrix}{μ}_{x} \\ {μ}_{y} \\ {μ}_{z}\end{matrix}\right] = \frac{1}{n} {\sum }_{i = 1}^{n} \left[\begin{matrix}{x}_{i} \\ {y}_{i} \\ {z}_{i}\end{matrix}\right] ; 2 \left[\begin{matrix}{\overline{x}}_{i} \\ {\overline{y}}_{i} \\ {\overline{z}}_{i}\end{matrix}\right] = \left[\begin{matrix}{x}_{i} \\ {y}_{i} \\ {z}_{i}\end{matrix}\right] - \left[\begin{matrix}{μ}_{x} \\ {μ}_{y} \\ {μ}_{z}\end{matrix}\right] ; 3 \left[\begin{matrix}{σ}_{x}^{2} \\ {σ}_{y}^{2} \\ {σ}_{Z}^{2}\end{matrix}\right] = \\ {\sum }_{i = 1}^{n} \left[\begin{matrix}{\overline{x}}_{i}^{2} \\ {\overline{y}}_{i}^{2} \\ {\overline{z}}_{i}^{2}\end{matrix}\right] .\end{matrix}$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of θ is estimated through atan2(bi, ai), and the vertices are ordered based on the value of θ. The table 1 below shows a combination of vertices for creating a triangle according to the number of the vertices. The vertices are ordered from 1 to n. The table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

Table 1. Triangles formed from vertices ordered 1,..., n

TABLE 1

| n | Triangles |
|---|---|
| 3 | (1,2,3) |
| 4 | (1,2,3), (3,4,1) |
| 5 | (1,2,3), (3,4,5), (5,1,3) |
| 6 | (1,2,3), (3,4,5), (5,6,1), (1,3,5) |
| 7 | (1,2,3), (3,4,5), (5,6,7), (7,1,3), (3,5,7) |
| 8 | (1,2,3), (3,4,5), (5,6,7), (7,8,1), (1,3,5), (5,7,1) |
| 9 | (1,2,3), (3,4,5), (5,6,7), (7,8,9), (9,1,3), (3,5,7), (7,9,3) |
| 10 | (1,2,3),(3,4,5), (5,6,7), (7,8,9),(9,10,1), (1,3,5), (5,7,9), (9,1,5) |
| 11 | (1,2,3),(3,4,5),(5,6,7), (7,8,9),(9,10,11), (11,1,3),(3,5,7),(7,9,11),(11,3,7) |
| 12 | (1,2,3), (3,4,5),(5,6,7),(7,8,9),(9,10,11),(11,12,1),(1,3,5),(5,7,9), (9,11,1), (1,5,9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

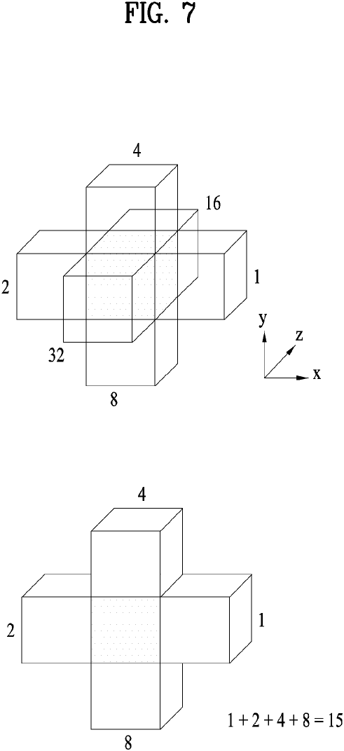

FIG. 7 shows an example of a neighbor node pattern according to embodiments.

In order to increase the compression efficiency of the point cloud video, the point cloud video encoder according to the embodiments may perform entropy coding based on context adaptive arithmetic coding. The point cloud video encoder may entropy encode based on a context adaptive arithmetic coding to enhance compression efficiency of the point cloud video.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 2³ = 8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The upper part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (for example, based on a table by which 64 is changed to 10 or 6).

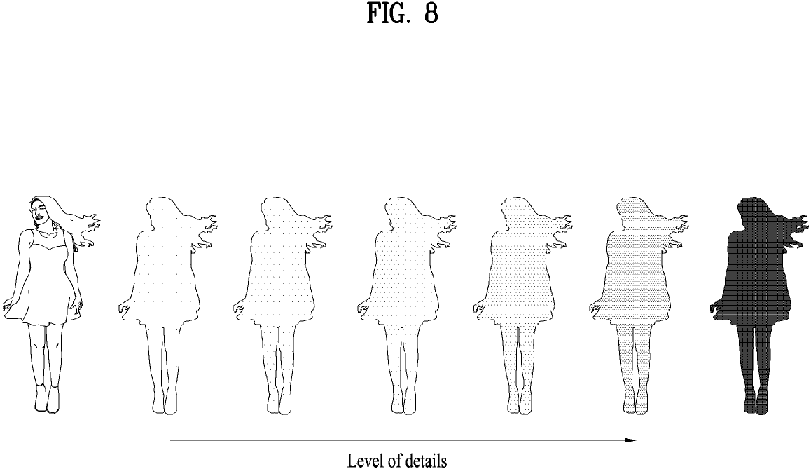

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (for example, the LOD generator 40009) may classify (or reorganize) points by LOD. FIG. 8 shows the point cloud content corresponding to LODs. The leftmost picture in FIG. 8 represents original point cloud content. The second picture from the left of FIG. 8 represents distribution of the points in the lowest LOD, and the rightmost picture in FIG. 8 represents distribution of the points in the highest LOD. That is, the points in the lowest LOD are sparsely distributed, and the points in the highest LOD are densely distributed. That is, as the LOD rises in the direction pointed by the arrow indicated at the bottom of FIG. 8, the space (or distance) between points is narrowed.

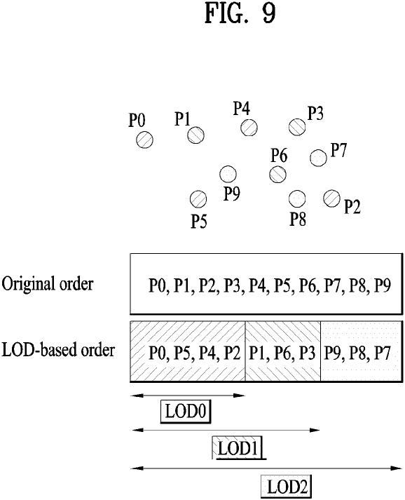

FIG. 9 illustrates an example of point configuration for each LOD according to embodiments.

As described with reference to FIGS. 1 to 8, the point cloud content providing system, or the point cloud video encoder (for example, the point cloud video encoder 10002 of FIG. 1, the point cloud video encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (for example, the coefficient quantizer 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in Tble 3.

TABLE 2

int PCCQuantization(int value, int quantStep) {
if( value >=0) {
return floor(value / quantStep + 1.0 / 3.0);
} else {
return -floor(-value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. 1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud video encoder (e.g., coefficient quantizer 40011) according to the embodiments quantizes the predicted attribute values. In addition, the point cloud video encoder (e.g., the arithmetic encoder 40012) performs entropy coding on the quantized attribute values.

The point cloud video encoder (for example, the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, g_{l_{x,y,z}} denotes the average attribute value of voxels at level l. g_{l_{x,y,z}} may be calculated based on g_{l+1_{2x,y,z}} and g_{l+1_{2x+1,y,z}}. The weights for g_{l_{2x,y,z}} and g_{l_{2x+1,y,z}} are w1 = w_{l_{2x,y,z}} and w2 = w_{l_{2x+1,y,z}}.

$$\begin{matrix}\left⌈\begin{matrix}{g}_{l - {1}_{x , y , z}} \\ {h}_{l - 1}\end{matrix}\right⌉ = {T}_{w 1 w 2} \left⌈\begin{matrix}{g}_{{l}_{2 x , y , z}} \\ {g}_{{l}_{2 x + 1 , y , z}}\end{matrix}\right⌉ {T}_{{w}_{1} {w}_{2}} = \frac{1}{\sqrt{w 1 + w 2}} \\ \left[\begin{matrix}\sqrt{w 1} & \sqrt{w 2} \\ - \sqrt{w 2} & \sqrt{w 1}\end{matrix}\right]\end{matrix}$$

Here, g_{l-1_{x,y,z}} is a low-pass value and is used in the merging process at the next higher level. h_{l-1_{x,y,z}} denotes high-pass coefficients. The high-pass coefficients at each step are quantized and subjected to entropy coding (for example, encoding by the arithmetic encoder 40012). The weights are calculated as w_{l-1_{x,y,z}} = w_{l_{2x,y,z}} + w_{l_{2x+1,y,z}}. The root node is created through the g_{1_{0,0,0}} and g_{1_{0,0,1}} as Equation 4.

$$\left⌈\begin{matrix}g D C \\ {h}_{{0}_{0 , 0 , 0}}\end{matrix}\right⌉ = {T}_{w 1000 w 1001} \left⌈\begin{matrix}{g}_{{1}_{0 , 0 , 0 z}} \\ {g}_{{1}_{0 , 0 , 1}}\end{matrix}\right⌉$$

The value of gDC is also quantized and subjected to entropy coding like the high-pass coefficients.

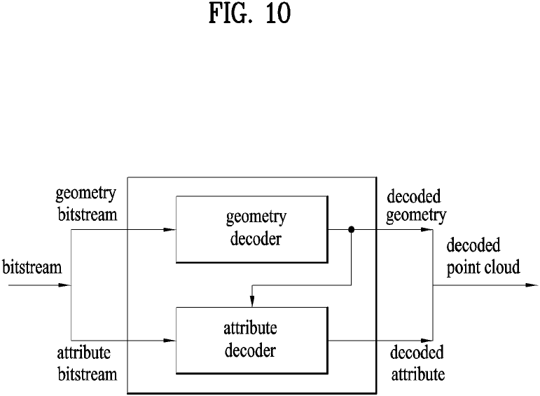

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

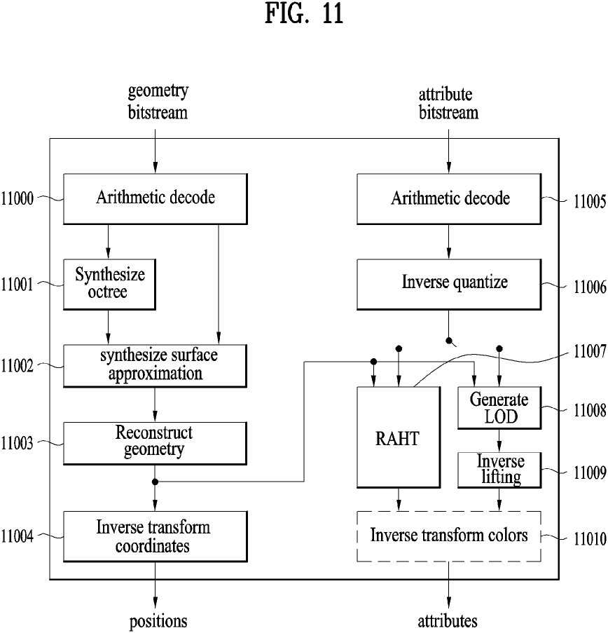

FIG. 11 illustrates a point cloud video decoder according to embodiments.

The point cloud video decoder illustrated in FIG. 11 is an example of the point cloud video decoder illustrated in FIG. 10, and may perform a decoding operation, which is a reverse process of the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

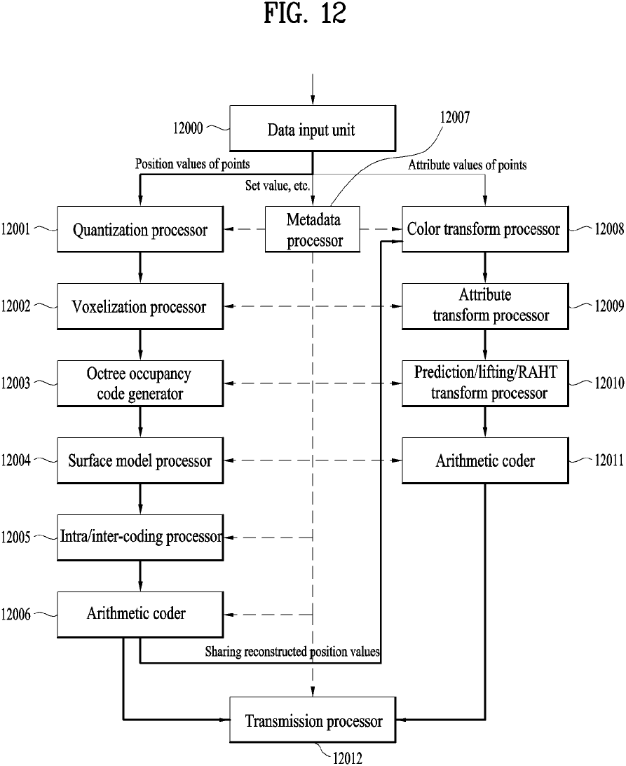

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analyzer 40002) described with reference to FIGS. 4 and 6. Details are the same as those described with reference to FIGS. 1 to 9.

The surface model processor 12004 may perform trigsoup geometry encoding based on a surface model to reconstruct the positions of points in a specific region (or node) on a voxel basis. The surface model processor 12004 may perform an operation and/or method the same as or similar to the operation and/or method of the point cloud video encoder (for example, the surface approximation analyzer 40003) described with reference to FIG. 4. Details are the same as those described with reference to FIGS. 1 to 9.

The intra/inter-coding processor 12005 may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. A detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. A detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 may encode the coded attributes based on the arithmetic coding. The arithmetic coder 12011 performs an operation and/or method the same as or similar to the operation and/or method of the arithmetic encoder 40012.

The transmission processor 12012 may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰. The TPS (or tile inventory) according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 may perform an operation and/or transmission method the same as or similar to the operation and/or transmission method of the transmitter 10003. Details are the same as those described with reference to FIGS. 1 and 2, and thus a description thereof is omitted.

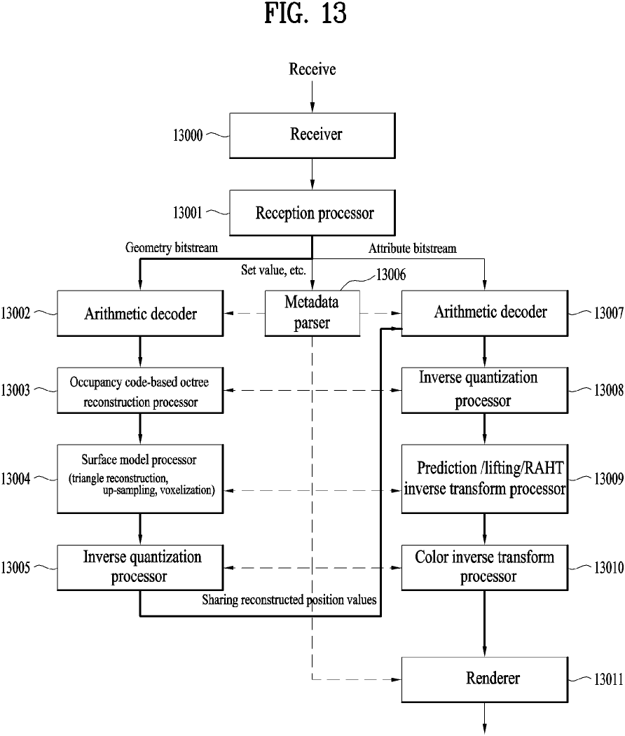

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment may include a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction /lifting/RAHT inverse transform processor 13009, a color inverse transform processor 13010, and/or a renderer 13011. Each element for decoding according to the embodiments may perform a reverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. A detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 may perform trisoup geometry decoding and related geometry reconstruction (for example, triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 may inversely quantize the decoded geometry.

The metadata parser 13006 may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transform processor 13009 may process the reconstructed geometry and the inversely quantized attributes. The prediction/lifting/RAHT inverse transform processor 13009 performs one or more of operations and/or decoding which are the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

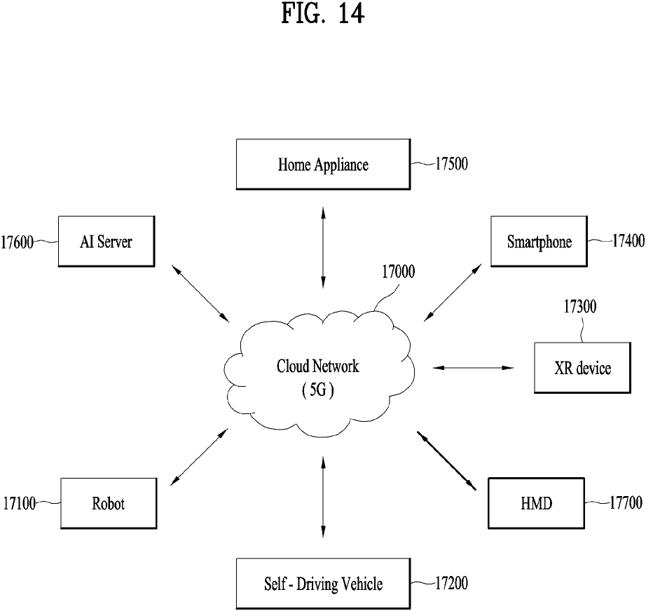

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17000. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception according to the above-described embodiments.

### PCC+XR

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

### PCC+Self-Driving+XR

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant’s eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described with reference to FIGS. 1 to 14, point cloud data is composed of a set of points, and each of the points may have geometry (or referred to as geometry information) and attributes (or referred to as attribute information). The geometry information is 3D position information (xyz information) about each point. That is, the position of each point is represented by parameters of a coordinate system representing a three-dimensional space (e.g., parameters x, y, and z for three axes representing the space, such as the X-axis, Y-axis, and Z-axis). In addition, the attribute information represents a color (RGB, YUV, etc.), reflectance, a normal vectors transparency, and the like of the point.

The point cloud data transmission device according to the embodiments may perform low-latency coding according to the characteristics of the content of the point cloud data. For example, when the point cloud data is data captured in real time from LiDAR or 3D map data transmitted in real time, the point cloud data transmission device needs to process the point cloud data to minimize delay and have high compression efficiency.

According to embodiments, the operation of encoding the point cloud data includes compressing geometry information based on octree, trisup or prediction, and compressing attribute information based on reconstructed geometry (= decoded geometry) information reconstructed based on position information changed through the compression. In addition, the decoding of the point cloud data includes receiving the encoded geometry bitstream and the attribute bitstream, decoding the geometry information based on octree, trisoup, or prediction, and decoding attribute information based on the geometry information reconstructed through the decoding.

The octree-based or trisup-based compression of the geometry information according to the embodiments has been described in detail with reference to FIGS. 4 to 13, and thus a description thereof will be omitted.

The prediction-based compression of the geometry information is performed by defining a prediction structure for the point cloud data. This structure is represented as a predictive tree having vertices associated with individual points of the point cloud data. The predictive tree may include a root vertex (or a root point) and a leaf vertex or a leaf point), and points below the root point may have at least one child. The depth increases toward the leaf point. The points may be predicted from the parent nodes in the predictive tree. According to embodiments, each point may be predicted by applying one of various prediction modes (e.g., no prediction, delta prediction, linear prediction, parallelogram predictor, etc.) based on the point positions of the parent, grand-parent, grand-grandparent, and the like of the point.

As such, in the prediction-based coding, prediction is performed based on neighbor point information related to the point cloud data. In addition, the prediction-based coding eliminates the need to wait for all point cloud data to be captured because step-by-step scanning of all points is not performed. In addition, the predictive tree coding allows captured point cloud data to be progressively encoded, and is therefore suitable for point cloud data content that requires low-latency processing.

Accordingly, the coding speed of the prediction-based coding is fast. However, as the encoding of the attribute information starts after the encoding of the geometry information (i.e., the information on the point position), a delay occurs. The delay is a hindrance that prevents fast procssing, which is the advantage of the prediction-based geometry coding from being fully utilized. That is, performing the geometry compression and the attribute compression by consecutive separate modules may take a long time. In particular, as the attribute compression is performed based on the result of the geometry compression, there is a limit in shortening the execution time.

According to the present disclosure, the delay between the geometry compression and the attribute compression may be eliminated by using the predictive tree structure used for prediction-based coding for the geometry and the attribute coding at the same time.

Next, a method of coding geometry information and attribute information simultaneously based on the predictive tree structure will be described. In particular, a description will be given of a method for generating a predictive tree in consideration of the adjacency of the geometry information and the attribute information in order to eliminate the delay between the geometry coding and the attribute coding and selecting an optimal prediction mode. The encoding and decoding methods for point cloud data described in the present disclosure may be used not only in applications for maximizing the low-latency effect of the prediction-based compression, but also in general point cloud attribute compression. In addition, the predictive tree generation method described in the present disclosure may be used independently for data compression.

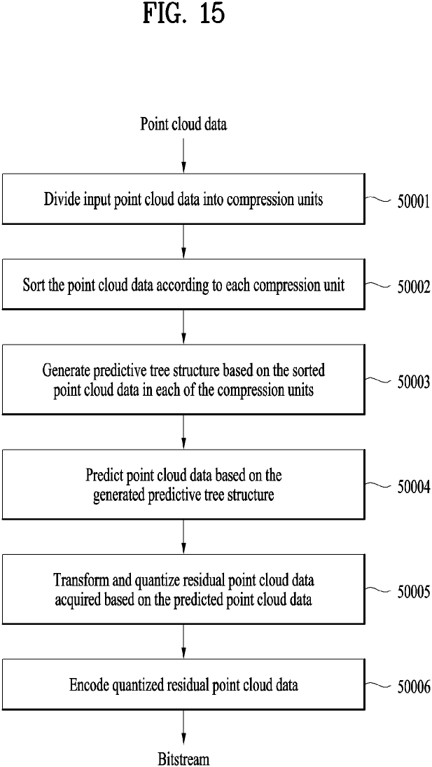

FIG. 15 is a flowchart illustrating a process of encoding point cloud data based on a predictive tree according to embodiments.

According to embodiments, the prediction-based point cloud data encoding process of FIG. 15 may be performed by the point cloud video encoder of FIGS. 1, 2, 4, 12, or 35. The point cloud video encoder of FIGS. 1, 2, 4, 12, or 35 may include one or more processors and one or more memories electrically or communicatively coupled with the one or more processors for the encoding of the point cloud data. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for processing the point cloud data.

According to embodiments, the prediction-based point cloud data decoding process of the reception device corresponding to the prediction-based point cloud data encoding of FIG. 15 may be performed by the point cloud video decoder of FIGS. 1, 2, 11, 13, or 38. The point cloud video decoder of FIGS. 1, 2, 11, 13, or 38 may include one or more processors and one or more memories electrically or communicatively coupled with the one or more processors for decoding of the point cloud data. In addition, the one or more processors may be configured as one or more physically separated hardware processors, a combination of software/hardware, or a single hardware processor. The one or more processors may be electrically and communicatively coupled with each other. Also, the one or more memories may be configured as one or more physically separated memories or a single memory. The one or more memories may store one or more programs for processing the point cloud data.

According to embodiments, the point cloud data input for the prediction-based point cloud data encoding is divided into compression units (or referred to as prediction units or specific units) (operation 50001). The point cloud data is sorted within the compression unit (operation 50002), and then a predictive tree structure is generated (operation 50003). Then, the geometry information and attribute information related to the point cloud data is predicted based on the generated predictive tree structure (operation 50004). Transformation and quantization are applied to residual information (or prediction error) obtained based on the predicted geometry information and attribute information (operation 50005), and then entropy encoding is performed (operation 50006).

According to embodiments, when prediction-based compression is performed in consideration of both the geometry information and the attribute information at the same time, the geometry information and the attribute information may be simultaneously considered in each operation, or information suitable for the characteristics of each operation may be considered first. As a result, a predictive tree considering both the geometry information and the attribute information may be constructed, and the geometry and attribute information may be simultaneously compressed per point.

Each operation in FIG. 15 is described in detail below.

### Configure a Data Compression Unit Considering Geometry and Attributes (Operation 50001)

According to embodiments, after input point cloud data is divided into compression units (or referred to as prediction units), sorting of the point cloud data, construction of a predictive tree, and prediction are performed within the compression units. That is, the point cloud data is encoded for each compression unit.

According to embodiments, one or more of various methods may be combined to configure or divide the point cloud data into compression units (or referred to as prediction units). For example, the entire point cloud data may be configured as one compression unit, or points locally adjacent to each other in terms of XYZ coordinates may be collected to configure a compression unit. Alternatively, point cloud data may be sorted in a specific order and then divided according to a specific number unit to configure a compression unit. Alternatively, the compression unit may be configured at the LoD level. Alternatively, a compression unit may be configured by collecting similar points according to a radius/azimuth/elevation in a cylindrical coordinate system. In this case, as the similarity between the parent and child in the predictive tree increases, the prediction performance may be enhanced, and thus the magnitude of the generated residual information may be reduced. Accordingly, in an embodiment of the present disclosure, a compression unit may be configured by grouping similar points. For example, the compression unit may be configured by collecting every specific number of similar points (e.g., 512, 1024, etc.). However, in the case where the compression unit is configured based on the order of input points and the case where the compression unit is configured based on the points sorted by the Morton code, there may be a big difference in compression efficiency even when the same prediction-based compression is used.

According to embodiments, when a compression unit is configured with points with high similarity, the following clustering may be used to consider features of geometry information and/or attribute information.

According to embodiments, clustering refers to an operation of dividing points into several clusters (or subgroups) when the points are given.

For example, when the centroid of the i-th cluster is ci and the set of points belonging to the i-th cluster is Si, Si maximizing the degree of cohesion of the j-th point pj in the cluster Si (that is, minimizing the difference between the points in each cluster) may be obtained in Equation 5 below. In the equation, | | denotes the distance between vectors, and may be typically defined as L1 norm or L2 norm. In addition, the centroid within the cluster Si may be obtained based on the average of coordinate values of points belonging to Si. According to embodiments, in order to obtain Si, a weighted norm in which a weight is applied to a specific element may be used.

$${s}_{i} = arg min {\sum }_{{p}_{j} ∈ {S}_{i}} {\left|{p}_{j} - {c}_{i}\right|}^{2}$$

In general, when calculating the distance between two points, the Manhattan distance calculation technique or Euclidean distance calculation technique is used. The Manhattan distance is called L1 distance, and the Euclidean distance is called L2 distance. In addition, a norm corresponding to the Manhattan distance is called a Manhattan norm or an L1 norm. A Euclidean space may be defined using the Euclidean distance, and a norm corresponding to this distance is called a Euclidean norm or an L2 norm. The norm is a method (function) of measuring the length or magnitude of a vector.

The distance between two clusters may be defined as a distance between the two centroids.

Therefore, as shown in Equation 6 below, as the distance Dᵢⱼ between the clusters increases, the distinction between the clusters may become clearer. Here, cᵢ denotes the centroid of the i-th cluster, and Cⱼ denotes the centroid of the j-th cluster.

$${D}_{i j} = \left|{c}_{i} - {c}_{j}\right|$$

That is, points may be divided to multiple clusters such that the distance between points in a cluster is minimized and the distance between points from different clusters is maximized.

To this end, Si that minimizes the overall variance V may be found as in Equation 7 below.

$$V \text{} = {\sum }_{i = 1}^{N} {{\sum }_{{p}_{j} ∈ {S}_{i}} \left|{p}_{j} - {c}_{i}\right|}^{2}$$

In this case, the j-th point pj included in the cluster Si may be defined according to the characteristics of the information to be considered as follows.

When geometry information is considered: pⱼ = [x_{j,}y_{j,}zⱼ]

When attribute information is considered: pⱼ = [rⱼ, gⱼ, bⱼ, Rⱼ]

When both the geometry information and the attribute information are considered: pⱼ = [xⱼ, yⱼ, zⱼ, Yⱼ, Cbⱼ, Crⱼ, Rⱼ]

In the definitions given above, x, y, and z denote geometry information on the X, Y, Z axes, r, g, and b or Y, Cb, and Cr denote color attribute information, and R denotes reflectance attribute information. According to embodiments, transformed geometry information or attribute information may be used or additional attribute information (normal, material, etc.) may be used.

For example, when both the geometry information and the attribute information are considered, the j-th point Pj belonging to Si is determined, considering both the geometry information and the attribute information about the j-th point.

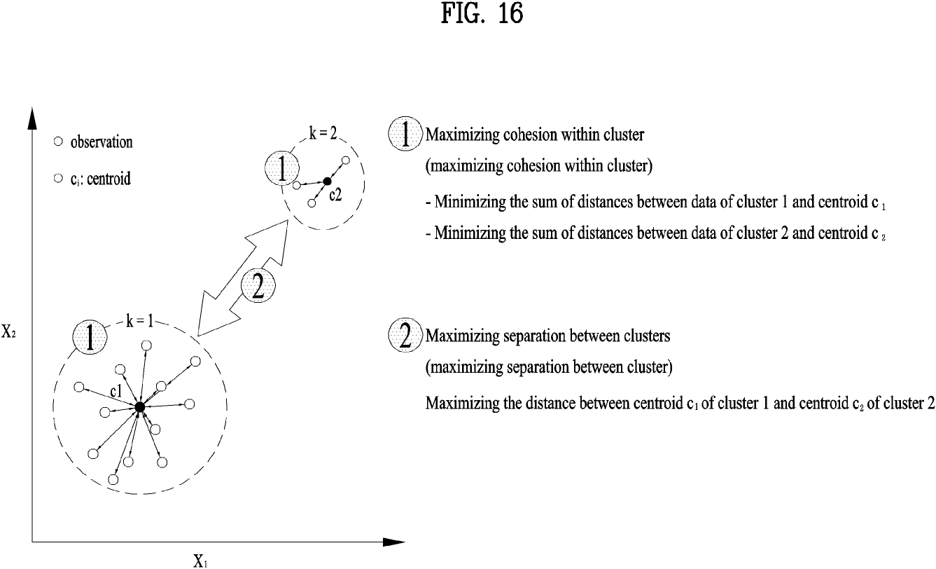

FIG. 16 is a diagram illustrating an example of obtaining a cluster according to embodiments.

When there are two clusters, S1 and S2 maximizing the cohesion in each cluster may be obtained as shown in FIG. 16.

For example, when only the geometry information is considered, clusters S1 and S2 are obtained such that the sum of the distances between the points and the centroid c1 of the cluster S1 is minimized and the sum of the distances between the points and the centroid c2 of the cluster S2 is minimized. In addition, clusters S1 and S2 are obtained such that the distance between the centroid c1 of the cluster S1 and the centroid c2 of the cluster S2 is maximized.

As another example, when only the attribute information is considered, the clusters S1 and S2 are obtained such that the attribute similarity between the points of the cluster S1 and the centroid c1 is maximized and the attribute similarity between the points of the cluster S2 and the centroid c2 is maximized. In addition, the clusters S1 and S2 are obtained such that the attribute similarity between the centroid c1 of the cluster S1 and the centroid c2 of the cluster S2 is minimized.

As another example, when both the geometry information and the attribute information are considered, the clusters S1 and S2 are obtained such that the sum of the distances between the points of the cluster S1 and the centroid c1 is minimized with the attribute similarity therebetween maximized, and the sum of the distances between the points of the cluster S2 and the centroid c2 is minimized with the attribute similarity therebetween maximized. In addition, the clusters S1 and S2 are obtained such that the distance between the centroid c1 of the cluster S1 and the centroid c2 of the cluster S2 is maximized with the attribute similarity therebetween minimized.

According to embodiments, each cluster may have the same number or a different number of points. Also, the number of points included in each cluster may be preset (to, for example, 512, 1024, or the like).

According to embodiments, a cluster represents a compression unit (or a prediction unit).

Sort point cloud data considering geometry and attributes (operation 50002)

As described above, once the points of the input point cloud data are divided into compression units (or referred to as prediction units) in consideration of geometry and/or attributes, the points of the point cloud data are sorted according to each compression unit. In this case, each compression unit may have the same number or a different number of points of the point cloud data. The number may be preset.

That is, as a method for increasing predictive compression efficiency for a compression unit, points of the point cloud data may be sorted in a predetermined order. That is, in the predictive coding, compression efficiency may be increased by disposing similar points so as to be adjacent to each other because prediction is performed based on similarity between adjacent points and then residual information (or referred to as a prediction error) is transmitted.

For example, when geometry information is considered, the points of the point cloud data in a compression unit may be sorted in Morton code order or Hilbert code order. Alternatively, points similar to each other in terms of radius, azimuth, or elevation in the cylindrical coordinate system may be grouped together.

As another example, when reflectance is considered in the attribute information, the points of the point cloud data in a compression unit may be sorted in ascending order of reflectance, and then attribute neighbor search may be performed.

As another example, when the color is considered in the attribute information, the points of the point cloud data in a compression unit may be sorted in ascending order of luma or in ascending order according to the order of green, blue, and red, or the colors may be sorted in Morton code order. That is, when the attribute information is considered, the points of the point cloud data in the compression unit may be sorted based on the similarity of the attribute information.

When both the geometry information and the attribute information are considered in sorting point cloud data within each compression unit, the point cloud data (xyzrgb) may be sorted according to the Morton code order and the Hilbert code order, as described above. According to embodiments, a sorting method may be determined in consideration of a clustering method. For example, when clustering is performed based on the geometry information, the sorting may be performed in consideration of the attribute information. That is, by arranging the point cloud data clustered based on the geometry according to the attribute similarity, the compression efficiency of the geometry information and the attribute information may be increased. As another example, when clustering is performed based on the attribute information, the sorting may be performed in consideration of the geometry information. That is, by sorting the point cloud data clustered based on the attribute according to the distance, the compression efficiency of the geometry information and the attribute information may be increased. As another example, the point cloud data may be clustered in consideration of both the geometry information and the attribute information, and the clustered point cloud data may be sorted in consideration of both the geometry information and the attribute information.

Generate a predictive tree based on geometry and attribute adjacency (operation 50003)

After the sorting of the points of the point cloud data in each compression unit is performed in operation 50002, a predictive tree may be constructed in each compression unit.

According to embodiments, a predictive tree may be constructed using a method of generating a geometry or attribute predictive tree structure. Accordingly, complexity may be reduced in a low-latency environment because the same structure may be used for compression of geometry information and compression of attribute information in point cloud compression. According to other embodiments, a predictive tree may be constructed considering both the geometry information and the attribute information to be compressed.

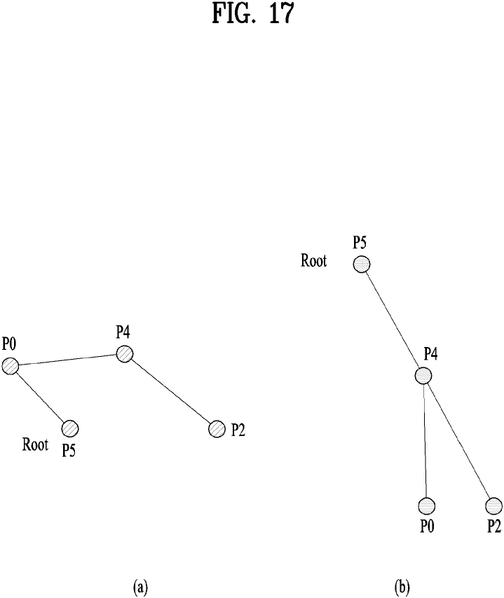

FIG. 17-(a) and FIG. 17-(b) are diagrams illustrating examples of predictive tree configuration according to embodiments.

According to embodiments, a predictive tree may be constructed by establishing a parent-child relationship between the points closest to each other with respect to a specific point.

For example, when it is assumed that four points P0, P2, P4, and P5 are present in a compression unit as shown in FIG. 17-(a) and P5 is closest to P0, P5 may be set as the root and P0 closest to P5 may be set as a child of P5. When it is assumed that P4 is closest to P0, P4 may be set as a child of P0. Accordingly, the relationship may be established in order of P5 - P0 - P4 - P2, and the relationship of grand-grandparent - grandparent - parent -child may be defined based on P2. Also, in order to find an adjacent point, the method of nearest neighbor search may be used based on the Euclidean distance.

When a predictive tree is generated in consideration of attribute information, the parent-child relationship may vary in the predictive tree. For example, for points P0, P4, and P2 that are adjacent to the root P5 in terms of position, when it is assumed that P4 has the highest similarity of the attribute component, the child of P5 may be P4 as shown in FIG. 17-(b). Also, when it is assumed that the attributes of P0 and P2 are more similar to P4 than to P5, P0 and P2 may be registered as children of P4.

As such, in constructing a predictive tree, the structure of the predictive tree may vary according to criteria for determining the distance and/or similarity between the points in a compression unit.

According to embodiments, when a predictive tree is constructed considering both the geometry information and the attribute information, the compression performance of the geometry information and the attribute information may be enhanced. In this case, the parent may be defined through a neighbor search in the compression unit (or referred to as a prediction unit). According to embodiments, a neighbor may be defined as at least one point having high attribute and geometry similarity. For example, when a geometry difference and an attribute difference between points are defined as in Equation 8 below, a point that minimizes the differences may be defined as a neighbor point.

$$\text{E} \text{} = \left(1 - {w}_{a}\right) {\left({g}_{i} - {g}_{p}\right)}^{2} + {w}_{a} {\left({a}_{i} - {a}_{p}\right)}^{2}$$

In Equation 8, gᵢ and aᵢ denote geometry information and attribute information about the i-th point (i.e., a neighbor point), and gₚ and aₚ denote geometry information and attribute information about the current point. wₐ is an adjacent attribute weight and has a value between 0 and 1. The predictive tree construction varies according to the adjacent attribute weight. When wₐ is close to 1, attribute similarity is considered relatively more important than geometry similarity, and thus points with similar attributes may become neighbors. On the other hand, when wₐ is close to 0, geometry similarity is considered more important than attribute similarity in constructing a predictive tree, and thus the probability that a point that is adjacent in terms of position becomes a neighbor increases.

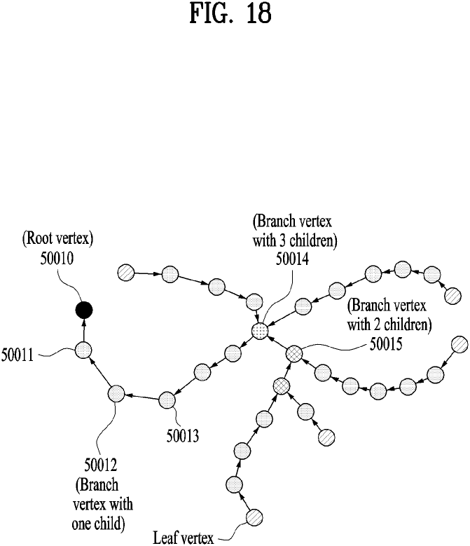

In addition, a predictive tree as shown in FIG. 18 may be constructed by establishing a parent-child relationship for points having a neighbor relationship.

FIG. 18 illustrates an example of a predictive tree structure generated in consideration of geometry and/or attributes according to embodiments.

In the final predictive tree, a point to be compressed (a specific point in a point cloud set having a relationship of a parent, a grandparent, a grand-grandparent, or the like as in FIG. 18) may be defined as a child, and and a prediction target point may be defined as a parent. Thereby, the parent-child relationship may be consecutively established. For example, when it is assumed that point 50013 is a point to be compressed, point 50012 is a parent of point 50013, point 50011 is a grandparent, and point 50010 is a grand-grandparent.

According to embodiments, in constructing a predictive tree, a point with which the compression starts is set as a root vertex. The point 50011 becomes a child having the root vertex (i.e., the root point) 50010 as a parent thereof. According to embodiments, it may be assumed that the point 50011 has the highest similarity to the root point 50010 based on the geometry and/or attributes. According to embodiments, a point (or vertex) having multiple children may be present in the predictive tree. According to embodiments, the number of children may be limited to a specific number (e.g., 3) or may be unlimited. For example, it is shown that point (or vertex) 50014 has three children, and point (vertex) 50015 has two children.

According to embodiments, predictive tree mode information (predictive_tree_mode) for identifying a method of constructing a predictive tree may be signaled in signaling information and delivered to a reception device. For example, predictive_tree_mode set to 0 may indicate that the predictive tree has been constructed considering only geometry information. predictive_tree_mode set to 1 may indicate that the predictive tree has been constructed considering only attribute information. predictive_tree_mode set to 2 may indicate that the predictive tree has been constructed considering both the geometry information and the attribute information. According to embodiments, the signaling information may be a sequence parameter set, a geometry parameter set, an attribute parameter set, and a tile parameter set (or referred to as a tile inventory). According to embodiments, predictive_tree_mode may be included in a slice carrying residual information (or referred to as a prediction error) and transmitted to the reception device. According to embodiments, the predictive tree mode information (predictive_tree_mode) may be referred to as information related to point cloud compression or information included in the information related to point cloud compression.

Predict points (geometry and attributes) based on the predictive tree (operation 50004)

Once the predictive tree is generated in consideration of geometry and/or attributes as described above in operation 50003, a point to be compressed is predicted.

According to embodiments, various prediction methods may be used for point prediction based on a geometry predictive tree structure and an attribute predictive tree structure. According to embodiments, prediction type information (prediction type) for identifying a prediction method used for the point prediction may be signaled in signaling information and delivered to the reception device. According to embodiments, the signaling information may be an SPS, GPS, APS, and TPS (or referred to as a tile inventory). According to embodiments, the prediction type information (prediction type) may be included in a slice carrying residual information (or referred to as a prediction error) and transmitted to the reception device. According to embodiments, the prediction method may be transmitted per point or may be transmitted per predetermined unit such as prediction unit. According to embodiments, the prediction type information may be referred to as information related to point cloud compression or information included in the information related to the point cloud compression.

According to embodiments, prediction type set to 0 may indicate a prediction using a prediction mode. Prediction type set to 1 may indicate a prediction using a neighbor attribute average. Prediction type set to 2 may indicate a prediction using a relationship between neighbor points. Prediction type set to 3 may indicate a prediction by transmitting a coefficient for the relationship between neighbor points is transmitted. The meaning, order, deletion, addition, or the like of the values assigned to the prediction type information can be easily changed by those skilled in the art, and therefor the present disclosure shall not be limited to the above embodiment.

Next, various prediction methods used for point prediction, in particular, prediction of attribute information will be described.

### Prediction Using a Prediction Mode (Prediction Type = 0)

Points may be predicted using a prediction mode in a predictive tree constructed based on the similarity of at least one of geometry information and attribute information. In predicting a point compressed, the prediction may be performed considering both the geometry and the attribute, only the geometry, or only the attribute. When the prediction is performed in consideration of both the geometry and the attribute, a greater weight may be assigned to the geometry or the attribute.

For example, suppose that P(n) is defined as a point to be compressed, that is, the n-th point in the predictive tree, and P(n-1) is defined as a parent point (or vertex) of the n-th point, P(n-2) is defined as a grandparent point of the n-th point, P(n-3) is defined as a grand-grandparent (or great-grandparent) point of the n-th point, and P(n-4) is defined as a grand-grand grandparent (or great-great grandparent) point of the n-th point. In this case, the prediction error (E) for each prediction mode may be defined as in Equation 9 below. For example, 7 values of the prediction error (E) may be calculated by applying the prediction modes of Equation 9 below to the point P(n), and a prediction mode having the least prediction error value among the seven calculated prediction error values may be set as the prediction mode of the point P(n). For example, when the prediction error value obtained by applying the second equation (E = |[P(n) - P(n -1)] - a * [P(n -1) - P(n -2)] - b|) is the least value (i.e., the value that minimizes the error) among the 7 prediction error values, prediction mode 2 (mode 2) may be set (selected) as the prediction mode of the point P(n). In addition, the information (pred_mode) indicating the set (selected) prediction mode and corresponding coefficient information (e.g., a, b, etc.) may be signaled in the signaling information and/or the slice and transmitted to the reception device. The signaling information may include parameter sets and a slice header carrying corresponding residual information.

$$\begin{matrix}\text{mode} \text{1:} \text{E} \text{=} \left|\text{P} \left(\text{n}\right) \text{-} \text{a} \text{*} \text{} \text{P} \left(\text{n-1}\right) \text{-b}\right| \\ \text{mode} \text{2:} \text{E} \text{=} \left|\left[\text{P} \left(\text{n}\right) \text{-} \text{P} \left(\text{n-1}\right)\right] \text{-} \text{a} \text{*} \left[\text{P} \left(\text{n-1}\right) \text{} - \text{P} \left(\text{n-2}\right)\right] - \text{b}\right| \\ \text{mode} 3 \text{:} \text{E} \text{=} \left|\left[\text{P} \left(\text{n}\right) \text{-} \text{P} \left(\text{n-1}\right)\right] / 2 - \text{a} \text{*} \left[\text{P} \left(\text{n-1}\right) \text{} + \text{P} \left(\text{n-2}\right)\right] / 2 - \text{b}\right| \\ \text{mode} 4 \text{:} \text{E} \text{=} \left|\left[\text{P} \left(\text{n}\right) \text{-} \text{P} \left(\text{n-1}\right)\right] \text{-} \text{a} \text{*} \left[\text{P} \left(\text{n-2}\right) \text{} - \text{P} \left(\text{n} \text{-3}\right)\right] - \text{b}\right| \\ \text{mode} 5 \text{:} \text{E} \text{=} \left|\left[\text{P} \left(\text{n}\right) + \text{P} \left(\text{n-1}\right) + \text{P} \left(\text{n-2}\right)\right] \text{/3} \text{-} \text{a} \text{*} \left[\text{P} \left(\text{n-1}\right) \text{} \text{+} \text{P} \left(\text{n} \text{-2}\right) \text{+} \text{P} \left(\text{n-3}\right)\right] \text{/3} \text{-} \left(\text{b}\right\}\right| \\ \text{mode} 6 \text{:} \text{E} \text{=} \left|\left[\text{P} \left(\text{n}\right) + \text{P} \left(\text{n-1}\right) + \text{P} \left(\text{n-2}\right)\right] \text{/3} \text{-} {\text{a}}^{,} \text{*} \left[\text{P} \left(\text{n-2}\right) \text{} \text{+} \text{P} \left(\text{n} \text{-3}\right) \text{+} \text{P} \left(\text{n-4}\right)\right] \text{/3} - {\text{b}}^{,}\right| \\ \text{mode} 7 \text{:} \text{E} \text{=} \left|\left[\text{P} \left(\text{n}\right) - 2 \text{P} \left(\text{n-1}\right) + \text{P} \left(\text{n-2}\right)\right] \text{-} {\text{a}}^{,} \text{*} \left[\text{P} \left(\text{n-1}\right) \text{-} 2 \text{} \text{P} \left(\text{n} \text{-2}\right) \text{+} \text{P} \left(\text{n-3}\right)\right] - \text{b}\right|\end{matrix}$$

Equation 10 below shows example equations for obtaining prediction information about each prediction mode. For example, when the prediction mode for the point P(n) selected by applying Equation 9 is prediction mode 2 (mode 2), the prediction information P′(n) corresponding to prediction mode 2 may be obtained by applying the second equation (P′(n) = (a+1) * P(n-1) - a * P(n-2) + b) in Equation 10. That is, P′(n) that minimizes the error for Equation 9 above may be predicted as in Equation 10 below.

$$\begin{matrix}\begin{matrix}\text{mode} \text{1:} {\text{P}}^{,} \left(\text{n}\right) \text{=} \text{a} \text{*} \text{P} \left(\text{n-1}\right) \text{+b}\end{matrix} \\ \begin{matrix}\text{mode} \text{2:} {\text{P}}^{\text{,}} \left(\text{n}\right) \text{=} \left(\text{a+1}\right) \text{*} \text{} \text{P} \left(\text{n-1}\right) \text{-} \text{a} \text{*} \text{P} \left(\text{n-2}\right) \text{+b} \\ \text{mode} 3 \text{:} {\text{P}}^{\text{,}} \left(\text{n}\right) \text{=} \left(\text{a+1}\right) \text{*} \text{} \text{P} \left(\text{n-1}\right) + \text{a} \text{*} \text{P} \left(\text{n-2}\right) \text{+} \text{2b} \\ \text{mode} \text{4:} {\text{P}}^{\text{,}} \left(\text{n}\right) \text{=} \text{P} \left(\text{n-1}\right) \text{+} \text{a} \text{*} \text{} \text{P} \left(\text{n-2}\right) - \text{a} \text{*} \text{P} \left(\text{n-3}\right) \text{+} \text{b} \\ \text{mode} \text{5:} {\text{P}}^{\text{′}} \left(\text{n}\right) \text{=} \left(\text{a-1}\right) \text{*} \text{P} \left(\text{n-1}\right) \text{} \text{+} \left(\text{a-1}\right) \text{*} \text{P} \left(\text{n-2}\right) \text{+} \text{a} \text{*} \text{P} \left(\text{n-3}\right) \text{+} \text{3b} \\ \text{mode} \text{6:} {\text{P}}^{\text{′}} \left(\text{n}\right) \text{=} \left(\text{n-1}\right) \text{+} \left(\text{a-1}\right) \text{*} \text{P} \left(\text{n-2}\right) \text{+} \text{a} \text{*} \text{P} \left(\text{n-3}\right) \text{+} \text{a} \text{*} \text{P} \left(\text{n-4}\right) \text{+} \text{3b} \\ \text{mode} \text{7:} {\text{P}}^{\text{′}} \left(\text{n}\right) \text{=} \left(\text{a+2}\right) \text{*} \text{P} \left(\text{n-1}\right) \text{-} \left(\text{2a+1}\right) \text{*} \text{P} \left(\text{n-1}\right) \text{} \text{+} \text{a} \text{*} \text{P} \left(\text{n-3}\right) \text{+} \text{b}\end{matrix}\end{matrix}$$

According to embodiments, the prediction error Res(n) of the point P(n) to be compressed may be obtained by subtracting the prediction information P′(n) of the prediction mode selected through Equations 9 and 10 from the geometry information and/or attribute information about the point P(n).

According to embodiments, the point P(n) to be compressed may be defined as follows according to the purpose. That is, when only geometry information is considered, the prediction mode of the point P(n) to be compressed may be obtained only for the geometry information through Equations 9 and 10. When only attribute information is considered, the prediction mode of the point P(n) to be compressed may be obtained only for the attribute information through Equations 9 and 10. In addition, when both the geometry information and the attribute information are considered, the prediction mode of the point P(n) to be compressed may be obtained for each of the geometry information and the attribute information through Equations 9 and 10. In this case, the prediction mode of the point P(n) to be compressed for the geometry information may be the same as or different from the prediction mode for the attribute information.

When geometry is considered: P(n)=g(n)=[xₙ, yₙ, z_{n]}

When attributes are considered: P(n)=a(n)=[rₙ, gₙ, bₙ, Rₙ]

When both the geometry and the attributes are considered: P(n)=[xₙ, yₙ, zₙ, Yₙ, Cbₙ, Crₙ, Rₙ]

According to embodiments, when both the geometry information and the attribute information are considered, different weights may be considered for the geometry information and the attribute information as follows.

When different weights are considered for geometry information and the attribute information: P(n)=[w_{g}xₙ, _{Wg}yₙ, w_{g}zₙ, wₐYₙ, wₐ Cbₙ, wₐCrₙ, wₐRₙ]

Here, w_{g} and wₐ are in the range of 0 to 1, and the sum of all weights is 1.

More generally, an independent weight may be used for each of the geometry and attribute elements as follows.

When different weights are considered for the geometry information and the attribute information: P(n)=[xₙ, yₙ, zₙ, Yₙ, Cbₙ, Crₙ, Rₙ] × [wₓ, w_{y}, w_{z}, w_{Y}, w_{Cb}, w_{Cr}, w_{R}]

According to embodiments, when the prediction error of the geometry information and the prediction error of the attribute information are considered together with weights assigned thereto, a prediction error (i.e., residual information) of the point P(n) to be compressed may be defined as the weighted sum of the prediction error of the geometry information and the prediction error of the attribute information, as shown in Equation 11 below.

$$\text{Res} \left(\text{n}\right) {\text{=E=w}}_{\text{g}} {\text{E}}_{\text{g}} \text{+} {\text{w}}_{\text{a}} \text{} {\text{E}}_{\text{a}}$$

Here, the prediction error E_{g} of the geometry information and the prediction error Eₐ of the attribute information may be obtained based on different prediction modes. For example, in Equations 9 and 10, the prediction error E_{g} of the geometry information may be determined based on prediction mode 2, and the prediction error Eₐ of the attribute information may be determined based on prediction mode 5. In another embodiment, the L1 norm and the L2 norm may be used differently for the geometry information and the attribute information. For example, the prediction error E_{g} of the geometry information may be obtained based on the Euclidean distance. For the attribute information, the prediction error Eₐ of the attribute information may be obtained by obtaining the Euclidean distance or measuring the color difference in a uniform color space (e.g., CIELa*b*) such as deltaE.

$$\begin{matrix}{E}_{a} \text{} = \sqrt{{\left({r}_{2} \text{} - {r}_{1}\right)}^{2} \text{} + {\left({g}_{2} - {g}_{1}\right)}^{2} \text{} + {\left({b}_{2} - {b}_{1}\right)}^{2}} \\ {E}_{a} \text{} = \sqrt{{\left({L}_{2} \text{} - {L}_{1}\right)}^{2} \text{} + {\left({a}_{2}^{*} - {a}_{1}^{*}\right)}^{2} \text{} + {\left({b}_{2}^{*} - {b}_{1}^{*}\right)}^{2}}\end{matrix}$$

According to embodiments, prediction mode indication information (geom_attr_same_prediction_mode_flag) for indicating whether the geometry information and the attribute information are compressed using the same method may be signaled in signaling information and delivered to the reception device. For example, geom_attr_same_prediction_mode_flag set to 1 may indicate that the geometry information and the attribute information use the same predictive tree and the same prediction coding parameter. geom_attr_same_prediction_mode_flag set to 0 may indicate that the geometry information and the attribute information use the same predictive tree while using different prediction coding parameters. For example, when a prediction error is determined based on prediction mode 2 for the geometry information and based on prediction mode 5 for the attribute information while the same predictive tree is used, geom_attr_same_prediction_mode_flag may be 0. According to embodiments, geom_attr_same_prediction_mode_flag may be referred to as information related to point cloud compression or information included in the information related to the point cloud compression.

According to embodiments, for the various prediction mode determination methods described above, a pre-designated method may be used/signaled per predetermined unit (e.g., compression unit (or prediction unit), slice, coding block, frame, or N units). Alternatively, a prediction mode (pred_mode) that minimizes the error may be signaled for every point. When the prediction mode is transmitted per predetermined unit, an operation of finding a prediction method that minimizes the total sum of prediction errors per point within the predetermined unit may be added. In addition, predetermined values of the prediction coefficients a and b (coeff_a, coeff_b) may be used/signaled. Alternatively, the prediction coefficients may be signaled for a method that minimizes the prediction error for every point or may be defined as a function that is inversely proportional to the distance between points. When the prediction of the geometry information and the prediction of the attribute information are independently performed, the above method may be applied to the geometry information and the attribute information, respectively. According to embodiments, the signaled information may be referred to as information related to point cloud compression or information included in the information related to the point cloud compression.

### Prediction Using a Neighbor Attribute Average (Prediction Type = 1)

According to embodiments, when it is assumed that when the points of the point cloud data are sorted in operation 50002, similar points are grouped and sorted within the compression unit, the point P(n) to be compressed may be predicted through averaging of neighbor attribute information. According to embodiments, the number of the neighbor attributes (num_neighbors) to be used for the averaging of the neighbor attribute information may be signaled in the signaling information and/or the slice and delivered to the reception device. Based on averaging of the attribute information as much as num_neigbbors of the neighbor attribute information starting from the parent, the child attribute (i.e., P(n)) may be predicted. According to embodiments, the averaging may use a distance-based weight as in Equation 13 below. Here, P′(n) is the prediction information about a point P(n) to be compressed. Therefore, the prediction error (or residual information, Res(n)) of the point P(n) to be compressed is obtained by subtracting P′(n) from P(n) (=P(n) - P′ (n)).

$${\text{P}}^{\text{′}} \left(\text{n}\right) = \text{sum} \left[\text{weight} \left(\text{n} - \text{k}\right) \text{} ∗ \text{P} \left(\text{n} - \text{k}\right)\right]$$

### Prediction Using a Relationship Between Neighbor Points (Prediction Type = 2)

According to embodiments, the attribute information about the point P(n) to be compressed may be predicted using a tendency of the attribute information. According to embodiments, the tendency of the attribute information may be predicted through linear regression for the distribution of neighbor attribute information.

According to embodiments, information (num_attr_parents_minus1) for indicating the number of parents used for attribute prediction and index information (parent_index) for indicating a point used for prediction repeatedly as many times as the number of parents may be signaled in the signaling information and/or slice and delivered to the reception device. Also, the prediction coefficients a and b may be directly transmitted to the reception device or may be estimated by the reception device. In this case, avg{A(p)} used for the prediction may represent the average of the attribute information centered on the current point as shown in Equation 14 below. Here, P′(n) is the prediction information about a point P(n) to be compressed. Therefore, the prediction error (or residual information, Res(n)) of the point P(n) to be compressed is obtained by subtracting P′(n) from P(n) (=P(n) - P′(n)).

$$\begin{matrix}{\text{P}}^{\text{′}} \left(\text{n}\right) \text{=} \text{a} \text{*} \text{avg} \left\{\text{P} \left(\text{n}\right)\right\} \text{+} \text{b} \\ \text{a} \text{=} \text{P} \left(\text{n-1}\right) \text{/} \text{} \text{avg} \left(\text{P} \left(\text{n-1}\right)\right) , \text{b} = \text{P} \left(\text{n-1}\right) \text{-} \text{a} ∗ \text{avg} \left\{\text{P} \left(\text{n-2}\right)\right\}\end{matrix}$$

### Prediction by Transmitting a Coefficient for the Relationship Between Neighbor Points (Prediction Type = 3)

According to embodiments, a coefficient for the tendency of the point P(n) that is to be compressed may be directly transmitted to the reception device. In this case, the same coefficient may be applied to num_same_coeff_pred_points points after the current point. Thus, by using similar coefficients as in Equation 15 when points having similar attribute information are gathered together in constructing a predictive tree, the bits required to transmit the coefficients may be reduced.

According to embodiments, in the case of prediction using the same coefficient for a certain points, information (num_same_coeff_pred_ponts) for indicating the number of points and corresponding coefficient information (coeff_c1 and coeff_c2) may be signaled in the signaling information and/or slice and delivered to the reception device.

In Equation 15 below, P′(n) is prediction information about a point P(n) to be compressed. Therefore, the prediction error (or residual information, Res(n)) of the point P(n) to be compressed is obtained by subtracting P′(n) from P(n) (=P(n) - P′ (n)).

$${\text{P}}^{\text{′}} \left(\text{n}\right) \text{=} \text{a} \text{*} \text{P} \left(\text{n-1}\right) \text{} \text{+} \text{b}$$

According to embodiments, for the various prediction mode methods described above, a pre-designated method may be used/signaled per predetermined unit (e.g., compression unit (or prediction unit), slice, coding block, frame, or N units). Alternatively, a prediction method that minimizes the error may be signaled for every point. When the prediction method is transmitted per predetermined unit, an operation of finding a prediction method that minimizes the total sum of prediction errors per point within the predetermined unit may be added. In addition, predetermined values of the prediction coefficients a and b may be used/signaled. Alternatively, the prediction coefficients may be signaled for a method that minimizes the prediction error for every point or may be defined as a function that is inversely proportional to the distance between points. According to embodiments, the signaled information may be referred to as information related to point cloud compression or information included in the information related to the point cloud compression.

### Transform and Quantization (Operation 50005)

According to embodiments, a prediction error (Res(n)=P(n) - P′(n)), which is a difference between the attribute information and/or geometry information about a point P(n) to be compressed and the prediction information P′(n) obtained by applying at least one of the above-described methods, may be transmitted to the reception device to increase coding efficiency.

According to embodiments, data may be reduced through normalization in an environment where data loss is allowed. In this case, different quantization values may be applied according to a group (or referred to as a compression unit or a prediction unit). This method may be intended to prevent an error from being transmitted by applying a small normalization value to data that is referenced many times.

For example, when inter-group reference is allowed, a quantization weight may be applied according to the number of times a group is referenced. Here, the quantization weight Q() may be defined to be inversely proportional to the number of times the group is referenced as follows.

$$\text{Quant} \left[\text{x}\right] \text{} \text{=} \text{FLOOR} \left[\text{Res} \left(\text{n}\right) / \text{Q} \left(\text{referred} \text{number} \text{} \text{of} \text{prediction} \text{group}\right)\right]$$

As another example, the quantization weight Q() may be applied according to the number of times a point is referenced in the predictive coding process. In this case, when when the point is the parent, grandparent, or grand-grandparent of an adjacent point and is defined to be used in generating the predictive tree in operation 50003 described above, the quantization weight Q() may be defined to be inversely proportional to the number of references of the point as follows.

$$\text{Quant} \left[\text{x}\right] \text{} \text{=} \text{FLOOR} \left[\text{Res} \left(\text{n}\right) / \text{Q} \left(\text{referred} \text{number} \text{} \text{of} \text{vertex}\right)\right]$$

As another example, the quantization weight Q() may be applied according to the order in which the vertices are coded from the root. In this case, when the number of parent-child relationships from the current vertex to the root (or a vertex serving as a specific reference) is defined as a vertex distance, the quantization weight Q() may be defined to be proportional to the vertex distance as follows.

$$\text{Quant} \left[\text{x}\right] \text{} \text{=} \text{FLOOR} \left[\text{Res} \left(\text{n}\right) / \text{Q} \left(\text{vertex} \text{distance} \text{} \text{from} \text{root}\right)\right]$$

As another example, the quantization weight Q() may be differently applied according to the number of child nodes. In this case, the quantization weight may be defined to be inversely proportional to the number of children as follows.

$$\text{Quant} \left[\text{x}\right] \text{} \text{=} \text{FLOOR} \left[\text{Res} \left(\text{n}\right) / \text{Q} \left(\text{number} \text{of} \text{} \text{children}\right)\right]$$

One or more of the quantization weights described above may be used in combination. In addition, in an environment where data loss is allowed, duplicate information between the prediction error (or residual information) values may be reduced through the transform. As an example of the transform that may be used according to embodiments, a lifting transform may be used.

As described above, after the transform and/or quantization are performed on the prediction error, entropy coding may be performed on the quantized prediction error and a bitstream may be output. In an embodiment, the entropy-coded and output bitstream may be in the form of a geometry-attribute bitstream containing both compressed geometry information and attribute information. That is, when geometry information and attribute information are compressed and entropy-encoded simultaneously based on the predictive tree structure, the bitstream output from the point cloud video encoder of any one of FIGS. 1, 2, 4, 12, and 35 may take the form of a geometry-attribute (geom-attr) bitstream containing both the geometry information and the attribute information.

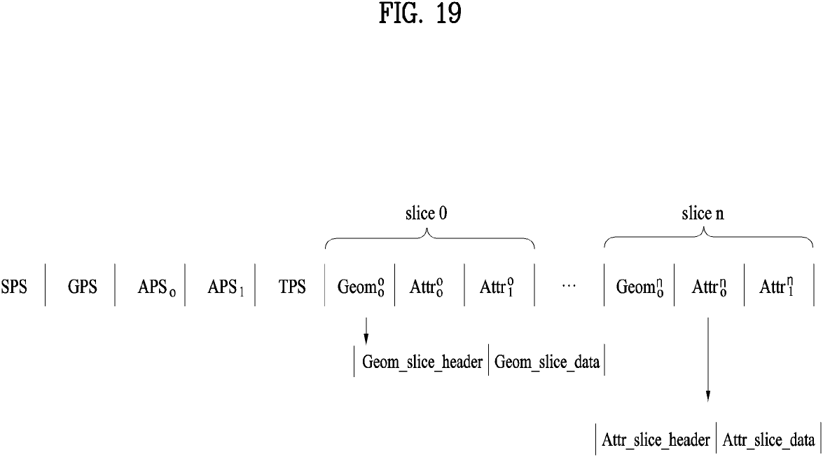

FIG. 19 illustrates an example of a bitstream structure of point cloud data for transmission/reception according to embodiments. That is, the bitstream structure is obtained when geometry information is first compressed, and then attribute information is compressed based on the reconstructed geometry information. According to the example, a geometry bitstream containing the compressed geometry information and an attribute bitstream containing the compressed attribute information are provided, respectively.

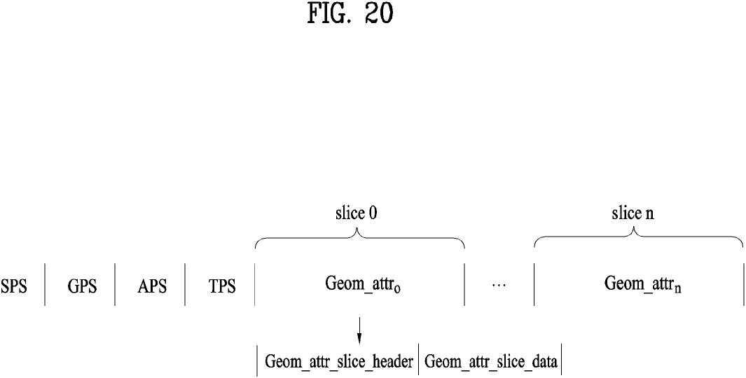

FIG. 20 illustrates another example of a bitstream structure of point cloud data for transmission/reception according to embodiments. That is, the bitstream structure is obtained when geometry information and attribute information are simultaneously compressed based on the predictive tree structure. According to the example, the compressed geometry information and attribute information are contained in one geometry-attribute bitstream.

According to embodiments, the bitstream output from the point cloud video encoder of any one of FIGS. 1, 2, 4, 12, and 35 may take the form of FIGS. 19 or 20, or the form of a combination of FIGS. 19 and 20.

The bitstream according to the embodiments may include a sequence parameter set (SPS) for sequence level signaling, a geometry parameter set (GPS) for signaling of geometry information coding, one or more attribute parameter sets (APSs) (APS0, APS1) for signaling of attribute information coding, a tile parameter set (TPS) (or tile inventory) for tile level signaling, and one or more slices (slice 0 to slice n). That is, the bitstream of the point cloud data according to the embodiments may contain one or more tiles, and each of the tiles may be a group of slices including one or more slices (slice 0 to slice n). The tile inventory (or TPS) may contain information about each of the one or more tiles (e.g., coordinate value information and height/size information about the tile bounding box). The SPS may include an identifier (seq_parameter_set_id) for identifying the SPS, and the GPS may include an identifier (geom_parameter_set_id) for identifying the GPS and an identifier (seq_parameter_set_id) indicating an active SPS to which the GPS belongs. The APS may include an identifier (attr_parameter_set_id) for identifying the APS and an identifier (seq_parameter_set_id) indicating an active SPS to which the APS belongs.

According to embodiments, each slice may include one geometry bitstream (Geom0) and/or one or more attribute bitstreams (Attr0 and Attr1). For example, slice 0 may include one geometry bitstream (Geom0⁰) and one or more attribute bitstreams (Attr0⁰ and Attr1⁰). According to embodiments, each slice may include one geometry-attribute bitstream (Geom-attr0). For example, slice 0 may include one geometry bitstream (Geom-attr0).

According to embodiments, the geometry bitstream may include a geometry slice header (geom_slice_header) and geometry slice data (geom_slice_data). The geom_slice_header may include an identifier (geom_parameter_set_id) of an active GPS to be referenced in a corresponding slice. The geom_slice_header may further include an identifier (geom_slice_id) for identifying the slice and/or an identifier (geom_tile_id) for identifying a corresponding tile. The geometry slice data may include a geometry bitstream belonging to the slice.

According to embodiments, the attribute bitstream may include an attribute slice header (attr_slice_header) and attribute slice data (attr_slice_data). The attr_slice_header may include an identifier (attr_parameter_set_id) of an active APS to be referenced in a corresponding slice and an identifier (geom_slice_id) for identifying a geometry slice related to the slice. The attribute slice data may include an attribute bitstream belonging to the slice.

According to embodiments, the geometry-attribute bitstream may include a geometry-attribute slice header (geom_attr_slice_header) of an active GPS and geometry-attribute slice data (geom_attr_slice_data). The geom_attr_slice_header may include an identifier (geom_parameter_set_id) and/or an identifier (attr_parameter_set_id) of an active APS to be referenced in a corresponding slice. Also, the geom_attr_slice_header may include an identifier (geom_attr_slice_id) for identifying the slice and/or an identifier (tile_id) for identifying a corresponding tile. The geometry-attribute slice data may include a geometry-attribute bitstream belonging to the slice.

According to embodiments, parameters necessary for encoding of the point cloud data may be newly defined in a parameter set of the point cloud data and/or a corresponding slice. For example, when the attribute information is encoded, the parameters may be added to the APS. When tile-based encoding is performed, the parameters may be added to the tile and/or slice.

According to embodiments, the bitstream of the point cloud data provides tiles or slices such that the point cloud data may be partitioned and processed by regions. The respective regions of the bitstream may have different importances. Accordingly, when the point cloud data is partitioned into tiles, a different filter (encoding method) and a different filter unit may be applied to each tile. When the point cloud data is partitioned into slices, a different filter and a different filter unit may be applied to each slice.

When the point cloud data is partitioned and compressed, the transmission device and the reception device according to the embodiments may transmit and receive a bitstream in a high-level syntax structure for selective transmission of attribute information in the partitioned regions.

The transmission device according to the embodiments may transmit point cloud data according to the bitstream structure as shown in FIG. 19 and/or FIG. 20. Accordingly, different encoding operations may be used according to the importance and a method to use a good-quality encoding method for an important region may be provided. In addition, efficient encoding and transmission may be supported according to the characteristics of the point cloud data, and an attribute value may be provided according to user requirements.

The reception device according to the embodiments may receive the point cloud data according to the bitstream structure as shown in FIG. 19 and/or FIG. 20. Accordingly, a complex decoding (filtering) method may not be applied to the entire point cloud data. Instead, different filtering (decoding) methods may be applied to the regions (regions partitioned into tiles or into slices), respectively. Therefore, better image quality may be ensured in a region important to the user and an appropriate latency may be ensured for the system.

A field, which is the term used in the syntaxes of the present disclosure described below, may have the same meaning as a parameter or an element.

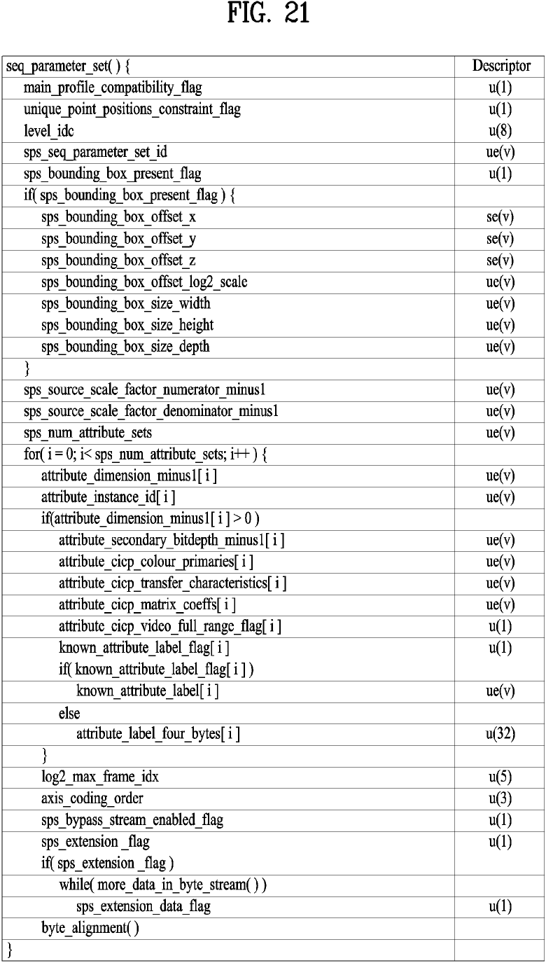

FIG. 21 shows an embodiment of a syntax structure of a sequence parameter set (SPS) (seq_parameter_set()) according to the present disclosure. The SPS may contain sequence information about a point cloud data bitstream.

The SPS according to the embodiments may include a main_profile compatibility_flag field, a unique_point_positions_constraint_flag field, a level_idc field, an sps_seq_parameter_set_id field, an sps_bounding_box_present_flag field, an sps_source_scale_factor_numerator_minus1 field, an sps_source_scale_factor_denominator_minus1 field, an sps_num_attribute_sets field, log2_max_frame_idx field, an axis_coding_order field, an sps_bypass_stream_enabled_flag field, and an sps_extension_flag field.

The main_profile_compatibility_flag field may indicate whether the bitstream conforms to the main profile. For example, main_profile_compatibility_flag equal to 1 may indicate that the bitstream conforms to the main profile. For example, main_profile_compatibility_flag equal to 0 may indicate that the bitstream conforms to a profile other than the main profile.

When unique_point_positions_constraint_flag is equal to 1, in each point cloud frame that is referred to by the current SPS, all output points may have unique positions. When unique_point_positions_constraint_flag is equal to 0, two or more output points may have the same position in any point cloud frame that is referred to by the current SPS. For example, even when all points are unique in the respective slices, points from different slices in a frame may overlap. In this case, unique_point_positions_constraint_flag should be set to 0.

level_idc indicates a level to which the bitstream conforms.

sps_seq_parameter_set_id provides an identifier for the SPS for reference by other syntax elements.

The sps_bounding_box_present_flag field indicates whether a bounding box is present in the SPS. For example, sps_bounding_box_present_flag equal to 1 indicates that the bounding box is present in the SPS, and sps_bounding_box_present_flag equal to 0 indicates that the size of the bounding box is undefined.

According to embodiments, when sps_bounding_box_present_flag is equal to 1, the SPS may further include an sps_bounding_box_offset_x field, an sps_bounding_box_offset_y field, an sps_bounding_box_offset_z field, an sps_bounding_box_offset_log2_scale field, an sps_bounding_box_size_width field, an sps_bounding_box_size_height field, and an sps_bounding_box_size_depth field.

sps_bounding_box_offset_x indicates the x offset of the source bounding box in Cartesian coordinates. When the x offset of the source bounding box is not present, the value of sps_bounding_box_offset_x is 0.

sps_bounding_box_offset_y indicates the y offset of the source bounding box in Cartesian coordinates. When the y offset of the source bounding box is not present, the value of sps_bounding_box_offset_y is 0.

sps_bounding_box_offset_z indicates the z offset of the source bounding box in Cartesian coordinates. When the z offset of the source bounding box is not present, the value of sps_bounding_box_offset_z is 0.

sps_bounding_box_offset_log2_scale indicates a scale factor for scaling quantized x, y, and z source bounding box offsets.

sps_bounding_box_size_width indicates the width of the source bounding box in Cartesian coordinates. When the width of the source bounding box is not present, the value of sps_bounding_box_size_width may be 1.

sps_bounding_box_size_height indicates the height of the source bounding box in Cartesian coordinates. When the height of the source bounding box is not present, the value of sps_bounding_box_size_height may be 1.

sps_bounding_box_size_depth indicates the depth of the source bounding box in Cartesian coordinates. When the depth of the source bounding box is not present, the value of sps_bounding_box_size_depth may be 1.

sps_source_scale_factor_numerator_minus1 plus 1 indicates the scale factor numerator of the source point cloud.

sps_source_scale_factor_denominator_minusl plus 1 indicates the scale factor denominator of the source point cloud.

sps_num_attribute_sets indicates the number of coded attributes in the bitstream.

The SPS according to the embodiments includes an iteration statement repeated as many times as the value of the sps_num_attribute_sets field. In an embodiment, i is initialized to 0, and is incremented by 1 each time the iteration statement is executed. The iteration statement is repeated until the value of i becomes equal to the value of the sps_num_attribute_sets field. The iteration statement may include an attribute_dimension_minus1[i] field and an attribute_instance_id[i] field. attribute_dimension_minus1[i] plus 1 indicates the number of components of the i-th attribute.

The attribute_instance_id[i] field specifies the instance ID of the i-th attribute.

According to embodiments, when the value of the attribute_dimension_minus1[i] field is greater than 1, the iteration statement may further include an attribute_secondary_bitdepth_minus1[i] field, an attribute cicp colour_primaries[i] field, an attribute_cicp_transfer_characteristics[i] field, an attribute_cicp_matrix_coeffs[i] field, and an attribute_cicp_video_full_range_flag[i] field.

attribute_secondary_bitdepth_minus1[i] plus 1 specifies the bitdepth for the secondary component of the i-th attribute signal(s).

attribute_cicp_colour_primaries[i] indicates the chromaticity coordinates of the color attribute source primaries of the i-th attribute.

attribute_cicp_transfer_characteristics[i] either indicates the reference optoelectronic transfer characteristic function of the color attribute as a function of a source input linear optical intensity with a nominal real-valued range of 0 to 1 or indicates the inverse of the reference electro-optical transfer characteristic function as a function of an output linear optical intensity

attribute_cicp_matrix_coeffs[i] describes the matrix coefficients used in deriving luma and chroma signals from the green, blue, and red, or Y, Z, and X primaries of the i-th attibute.

attribute_cicp_video_full_range_flag[i] specifies the black level and range of the luma and chroma signals as derived from E′Y, E′PB, and E′PR or E′R, E′G, and E′B real-valued component signals of the i-th attibute.

The known_attribute_label_flag[i] field indicates whether a know_attribute_label[i] field or an attribute_label_four_bytes[i] field is signaled for the i-th attribute. For example, when known_attribute_label_flag[i] equal to 0 indicates the known_attribute_label[i] field is signaled for the i-th attribute. known_attribute_label_flag[i] equal to 1 indicates that the attribute_label_four_bytes[i] field is signaled for the i-th attribute.

known_attribute_label[i] specifies the type of the i-th attribute. For example, known_attribute_label[i] equal to 0 may specify that the i-th attribute is color. known_attribute_label[i] equal to 1 may specify that the i-th attribute is reflectance. known_attribute_label[i] equal to 2 may specify that the i-th attribute is frame index. Also, known_attribute_label[i] equal to 4 specifies that the i-th attribute is transparency. known_attribute_label[i] equal to 5 specifies that the i-th attribute is normals.

attribute_label_four_bytes[i] indicates the known attribute type with a 4-byte code.

According to embodiments, attribute_label_four_bytes[i] equal to 0 may indicate that the i-th attribute is color. attribute_label_four_bytes[i] equal to 1 may indicate that the i-th attribute is reflectance. attribute_label_four_bytes[i] equal to 2 may indicate that the i-th attribute is a frame index. attribute_label_four_bytes[i] equal to 4 may indicate that the i-th attribute is transparency. attribute_label_four_bytes[i] equal to 5 may indicate that the i-th attribute is normals.

log2_max_frame_idx indicates the number of bits used to signal a syntax variable frame_idx.

axis_coding_order specifies the correspondence between the X, Y, and Z output axis labels and the three position components in the reconstructed point cloud RecPic [pointidx] [axis] with and axis=0..2.

sps_bypass_stream_enabled_flag equal to 1 specifies that the bypass coding mode may be used in reading the bitstream. As another example, sps_bypass_stream_enabled_flag equal to 0 specifies that the bypass coding mode is not used in reading the bitstream.

sps_extension_flag indicates whether the sps_extension_data syntax structure is present in the SPS syntax structure. For example, sps_extension_present_flag equal to 1 indicates that the sps_extension_data syntax structure is present in the SPS syntax structure. sps_extension_present_flag equal to 0 indicates that this syntax structure is not present.

When the value of the sps_extension_flag field is 1, the SPS according to the embodiments may further include an sps_extension_data_flag field.

sps_extension_data_flag may have any value.

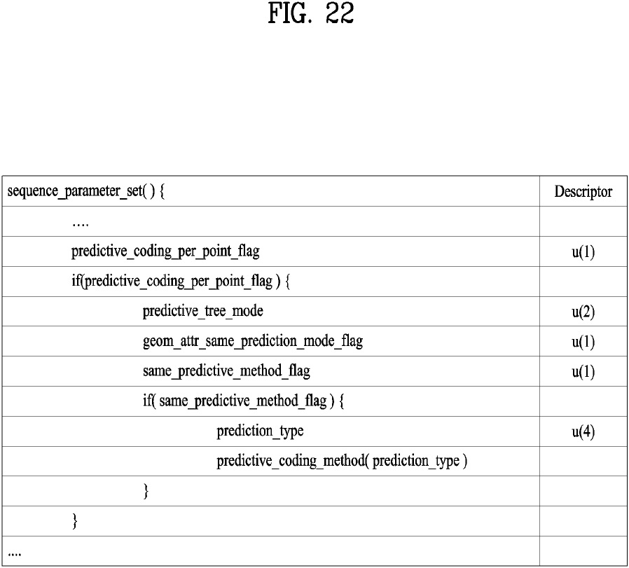

FIG. 22 shows an embodiment of a syntax structure of a sequence parameter set (sequence_parameter_set()) (SPS) including information related to point cloud compression according to embodiments.

In FIG. 22, the information related to the point cloud compression may include a predictive_coding_per_point_flag field.

predictive_coding_per_point_flag set to 1 may indicate that geometry information and attribute information are compressed together (or simultaneously) through predictive coding. predictive_coding_per_point_flag set to 0 may indicate that the geometry information and the attribute information are compressed separately. That is, predictive_coding_per_point_flag set to 1 may indicate that the geometry information and the attribute information are compressed simultaneously based on the predictive tree described with reference to FIG. 15. Also, predictive_coding_per_point_flag set to 0 may indicate that the geometry information is first compressed and the attribute information is compressed based on the reconstructed geometry information.

According to embodiments, when the value of the predictive_coding_per_point_flag field is 1, the information related to point cloud compression may further include a predictive_tree_mode field, a geom_attr_same_prediction_mode_flag field, and a same_predictive_method_flag field.

The predictive_tree_mode field may indicate a method of constructing a predictive tree. For example, predictive_tree_mode set to 0 may indicate that the predictive tree is constructed considering only the geometry information. predictive_tree_mode set to 1 may indicate that the predictive tree is constructed considering only the attribute information. predictive_tree_mode set to 2 may indicate that the predictive tree is constructed considering geometry and attributes together (or at the same time).

geom_attr_same_prediction_mode_flag set to 1 may indicate that the geometry information and the attribute information are compressed using the same method. In this case, the same predictive tree and the same predictive coding parameter may be used. geom_attr_same_prediction_mode_flag set to 0 may indicate that the same predictive tree and different parameters are used for the geometry information and the attribute information.

same_predictive_method_flag field set to 1 may indicate that the same prediction method is used in a sequence.

According to embodiments, when the value of the same_predictive_method_flag field is 1, the information related to point cloud compression may further include a prediction_type field and predictive_coding_method(prediction_type).

The prediction_type field may indicate a prediction method for the attribute information. For example, prediction_type set to 0 may indicate a method of delivering the attribute prediction mode. prediction_type set to 1 may indicate prediction prediction_type set to 1 may indicate the average of neighbor points. prediction_type set to 2 may indicate prediction according to the attribute tendency based on multiple parents. prediction_type set to 3 may indicate prediction using coefficients based on a linear relationship with a parent.

The predictive_coding_method(prediction_type) may further include additional information related to attribute compression according to the value of the prediction_type field.

According to embodiments, when the predictive_coding_method(prediction_type) is signaled in the sequence parameter set (SPS), it indicates that the same prediction method is used for all sequences. When the predictive_coding_method(prediction_type) is signaled in the tile parameter set, the geometry parameter set, or the attribute parameter set (or frame parameter set), it indicates that the same prediction method is used in the current frame. Also, according to embodiments, when the predictive_coding_method(prediction_type) is signaled in the slice header, it may indicate that the same prediction method is used in the slice. Different methods may be signaled according to points.

According to embodiments, the information related to the point cloud compression of FIG. 22 may be included at any position in the SPS of FIG. 21.

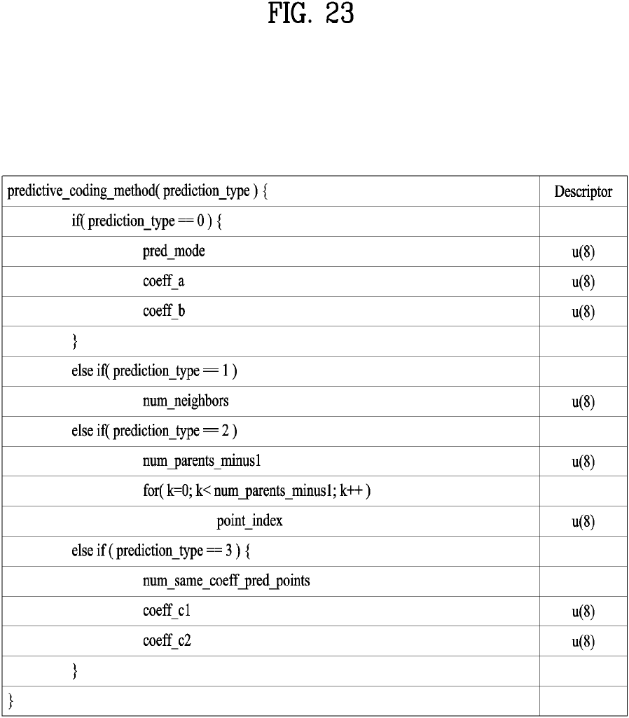

FIG. 23 shows an exemplary syntax structure of predictive_coding_method(prediction_type) according to embodiments.

As described above, predictive_coding_method(prediction_type) may be included in at least one of SPS, GPS, APS, TPS, a frame parameter set, and a slice.

The predictive_coding_method(prediction_type) may further include information related to attribute compression according to the value of prediction_type.

That is, when the value of prediction_type is 0, the information related to the attribute compression may further include a pred_mode field, a coeff_a field, and a coeff_b field.

pred_mode indicates a prediction mode used in the method of compressing the attribute information.

coeff_a and coeff_b may indicate related prediction coefficient values (e.g., a and b) used in the method of compressing the attribute information.

When the value of the prediction_type field is 1, the information related to the attribute compression may further include a num_neighbors field.

num_neighbors may indicate the number of neighbor points used for the average of neighbor attributes. According to embodiments, it may have a meaning as the number of points from the parent of a point to be predicted to the root.

When the value of the prediction_type field is 2, the information related to the attribute compression may further include a num_parents_minus 1 field.

num_parents_minus1 plus 1 may indicate the number of parents used for prediction of the attribute information.

point_index as many as the value of num_parents_minus1 may be further included.

parent_index indicates an index for referring to a point used for the prediction.

When the value of the prediction_type field is 3, the information related to the attribute compression may further include a num_same_coeff_pred_points field, a coeff_c1 field, and a coeff_c2 field.

num_same_coeff_pred_ponts may indicate the number of points when the prediction is performed using the same coefficient for the points.

coeff_c1 and coeff_c2 may indicate values of coefficients when the prediction is performed using the same coefficients for the corresponding points.

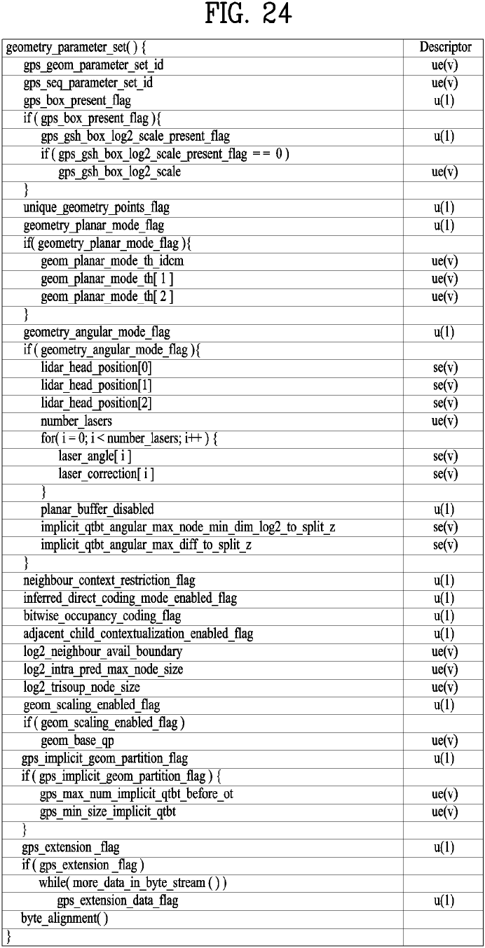

FIG. 24 shows an embodiment of a syntax structure of the GPS (geometry_parameter_set()) according to the present disclosure. The GPS may include information on a method of encoding geometry information of point cloud data included in one or more slices.

According to embodiments, the GPS may include a gps_geom_parameter_set_id field, a gps_seq_parameter_set_id field, gps_box_present_flag field, a unique_geometry_points_flag field, a geometry_planar_mode_flag field, a geometry _angular_mode_flag field, a neighbour_context_restriction_flag field, a inferred_direct_coding_mode_enabled_flag field, a bitwise_occupancy_coding_flag field, an adjacent_child_contextualization_enabled_flag field, a log2_neighbour_avail_boundary field, a log2_intra_pred_max_node_size field, a log2_trisoup_node_size field, a geom_scaling_enabled_flag field, a gps_implicit_geom_partition_flag field, and a gps_extension_flag field.

The gps_geom_parameter_set_id field provides an identifier for the GPS for reference by other syntax elements.

The gps_seq_parameter_set_id field specifies the value of sps_seq_parameter_set_id for the active SPS.

The gps_box_present_flag field specifies whether additional bounding box information is provided in a geometry slice header that references the current GPS. For example, the gps_box_present_flag field equal to 1 may specify that additional bounding box information is provided in a geometry slice header that references the current GPS. Accordingly, when the gps_box_present_flag field is equal to 1, the GPS may further include a gps_gsh_box_log2_scale_present_flag field.

The gps_gsh_box_log2_scale_present_flag field specifies whether the gps_gsh_box_log2_scale field is signaled in each geometry slice header that references the current GPS. For example, the gps_gsh_box_log2_scale_present_flag field equal to 1 may specify that the gps_gsh_box_log2_scale field is signaled in each geometry slice header that references the current GPS. As another example, the gps_gsh_box_log2_scale_present_flag field equal to 0 may specify that the gps_gsh_box_log2_scale field is not signaled in each geometry slice header and a common scale for all slices is signaled in the gps_gsh_box_log2_scale field of the current GPS.

When the gps_gsh_box_log2_scale_present_flag field is equal to 0, the GPS may further include a gps_gsh_box_log2_scale field.

The gps_gsh_box_log2_scale field indicates the common scale factor of the bounding box origin for all slices that refer to the current GPS.

unique_geometry_points_flag indicates whether all output points have unique positions in one slice in all slices currently referring to GPS. For example, unique_geometry_points_flag equal to 1 indicates that in all slices that refer to the current GPS, all output points have unique positions within a slice. unique_geometry_points_flag field equal to 0 indicates that in all slices that refer to the current GPS, the two or more of the output points may have same positions within a slice.

The geometry_planar_mode_flag field indicates whether the planar coding mode is activated. For example, geometry_planar_mode_flag equal to 1 indicates that the planar coding mode is active. geometry_planar_mode_flag equal to 0 indicates that the planar coding mode is not active.

When the value of the geometry_planar_mode_flag field is 1, that is, TRUE, the GPS may further include a geom_planar_mode_th_idcm field, a geom_planar_mode_th[1] field, and a geom_planar_mode_th[2] field.

The geom_planar_mode_th_idcm field may specify the value of the threshold of activation for the direct coding mode.

geom_planar_mode_th[i] specifies, for i in the range of 0...2, specifies the value of the threshold of activation for planar coding mode along the i-th most probable direction for the planar coding mode to be efficient.

geometry_angular_mode_flag indicates whether the angular coding mode is active. For example, geometry_angular_mode_flag field equal to 1 may indicate that the angular coding mode is active. geometry_angular_mode_flag field equal to 0 may indicate that the angular coding mode is not active.

When the value of the geometry_angular_mode_flag field is 1, that is, TRUE, the GPS may further include an lidar_head_position[0] field, a lidar_head_position[1] field, a lidar_head_position[2] field, a number_lasers field, a planar_buffer_disabled field, an implicit_qtbt_angular_max_node_min_dim_log2_to_split_z field, and an implicit_qtbt_angular_max_diff_to_split_z field.

The lidar_head_position[0] field, lidar_head_position[1] field, and lidar_head_position[2] field may specify the (X, Y, Z) coordinates of the lidar head in the coordinate system with the internal axes..

number_lasers specifies the number of lasers used for the angular coding mode.

The GPS according to the embodiments includes an iteration statement that is repeated as many times as the value of the number_lasers field. In an embodiment, i is initialized to 0, and is incremented by 1 each time the iteration statement is executed. The iteration statement is repeated until the value of i becomes equal to the value of the number_lasers field. This iteration statement may include a laser_angle[i] field and a laser_correction[i] field.

laser_angle[i] specifies the tangent of the elevation angle of the i-th laser relative to the horizontal plane defined by the 0-th and the 1st internal axes.

laser_correction[i] specifies the correction, along the second internal axis, of the i-th laser position relative to the lidar_head_position[2].

planar_buffer_disabled equal to 1 indicates that tracking the closest nodes using a buffer is not used in process of coding the planar mode flag and the plane position in the planar mode. planar_buffer_disabled equal to 0 indicates that tracking the closest nodes using a buffer is used.

implicit_qtbt_angular_max_node_min_dim_log2_to_split_z specifies the log2 value of a node size below which horizontal split of nodes is preferred over vertical split.

implicit_qtbt_angular_max_diff_to_split_z specifies the log2 value of the maximum vertical over horizontal node size ratio allowed to a node.

neighbour_context_restriction_flag equal to 0 indicates that geometry node occupancy of the current node is coded with the contexts determined from neighbouring nodes which is located inside the parent node of the current node. neighbour_context_restriction_flag equal to 1 indicates that geometry node occupancy of the current node is coded with the contexts determined from neighbouring nodes which is located inside or outside the parent node of the current node.

The inferred_direct_coding_mode_enabled_flag field indicates whether the direct_mode_flag field is present in the geometry node syntax. For example, the inferred_direct_coding_mode_enabled_flag field equal to 1 indicates that the direct_mode_flag field may be present in the geometry node syntax. For example, the inferred_direct_coding_mode_enabled_flag field equal to 0 indicates that the direct_mode_flag field is not present in the geometry node syntax.

The bitwise_occupancy_coding_flag field indicates whether geometry node occupancy is encoded using bitwise contextualization of the syntax element occupancy map. For example, the bitwise_occupancy_coding_flag field equal to 1 indicates that geometry node occupancy is encoded using bitwise contextualisation of the syntax element ocupancy_map. For example, the bitwise_occupancy_coding_flag field equal to 0 indicates that geometry node occupancy is encoded using the dictionary encoded syntax element occupancy_byte.

The adjacent_child_contextualization_enabled_flag field indicates whether the adjacent children of neighboring octree nodes are used for bitwise occupancy contextualization. For example, the adjacent_child_contextualization_enabled_flag field equal to 1 indicates that the adjacent children of neighboring octree nodes are used for bitwise occupancy contextualization. For example, adjacent_child_contextualization_enabled_flag equal to 0 indicates that the children of neighbouring octree nodes are not used for the occupancy contextualization. The log2_neighbour_avail_boundary field specifies the value of the variable NeighbAvailBoundary that is used in the decoding process.

For example, when the neighbour_context_restriction_flag field is equal to 1, NeighbAvailabilityMask may be set equal to 1. For example, when the neighbour_context_restriction_flag field is equal to 0, NeighbAvailabilityMask may be set equal to 1 << log2_neighbour_avail_boundary.

The log2_intra_pred_max_node_size field specifies the octree node size eligible for occupancy intra prediction.

The log2_trisoup_node_size field specifies the variable TrisoupNodeSize as the size of the triangle nodes.

geom_scaling_enabled_flag indicates specifies whether a scaling process for geometry positions is applied during the geometry slice decoding process. For example, geom_scaling_enabled_flag equal to 1 specifies that a scaling process for geometry positions is applied during the geometry slice decoding process. geom_scaling_enabled_flag equal to 0 specifies that geometry positions do not require scaling.

geom_base_qp indicates the base value of the geometry position quantization parameter.

gps_implicit_geom_partition_flag indicates whether the implicit geometry partition is enabled for the sequence or slice. For example, equal to 1 specifies that the implicit geometry partition is enabled for the sequence or slice. gps_implicit_geom_partition_flag equal to 0 specifies that the implicit geometry partition is disabled for the sequence or slice. When gps_implicit_geom_partition_flag is equal to 1, the following two fields, that is, a gps_max_num_implicit_qtbt_before_ot field and a gps_min_size_implicit_qtbt field, are signaled.

gps_max_num_implicit_qtbt_before_ot specifies the maximal number of implicit QT and BT partitions before OT partitions. Then, the variable K is initialized by gps_max_num_implicit_qtbt_before_ot as follows.

$$\text{K} \text{} \text{=} \text{gps\_max\_num\_implicit\_qtbt\_before\_ot} \text{.}$$

gps_min_size_implicit_qtbt specifies the minimal size of implicit QT and BT partitions. Then, the variable M is initialized by gps_min_size_implicit_qtbt as follows.

$$\text{M} \text{=} \text{gps\_min\_size\_implicit\_qtbt}$$

gps_extension_flag indicates whether a gps_extension_data syntax structure is present in the GPS syntax structure. For example, gps_extension_flag equal to 1 indicates that the gps_extension_data syntax structure is present in the GPS syntax. For example, gps_extension_flag equal to 0 indicates that the gps_extension_data syntax structure is not present in the GPS syntax.

When gps_extension_flag is equal to 1, the GPS according to the embodiments may further include a gps_extension_data_flag field.

gps_extension_data_flag may have any value. Its presence and value do not affect decoder conformance to profiles.

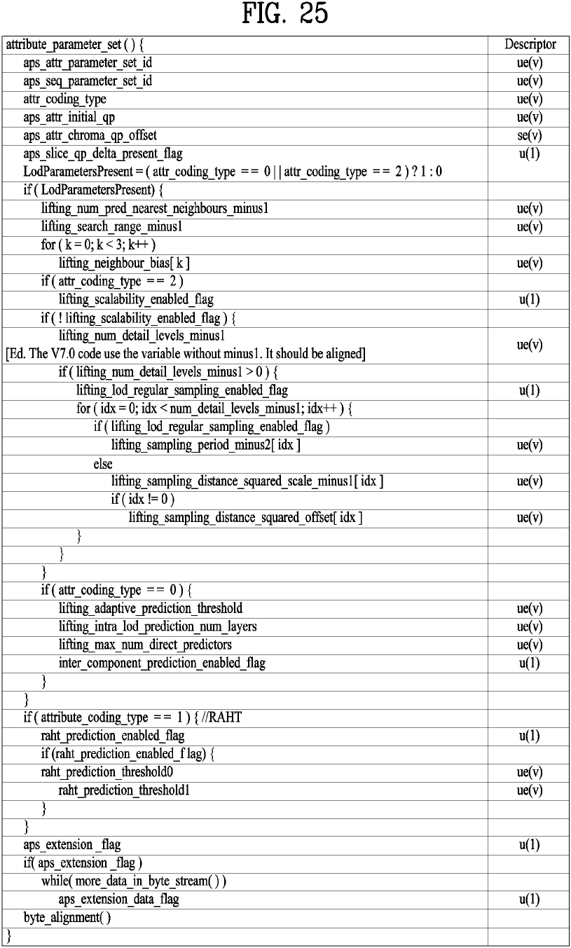

FIG. 25 shows an embodiment of a syntax structure of the attribute parameter set (APS) (attribute_parameter_set()) according to the present disclosure. The APS according to the embodiments may contain information on a method of encoding attribute information about point cloud data contained in one or more slices.

The APS according to the embodiments may include an aps_attr_parameter_set_id field, an aps_seq_parameter_set_id field, an attr_coding_type field, an aps_attr_initial_qp field, an aps_attr_chroma_qp_offset field, an aps_slice_qp_delta_present_flag field, and an aps_extension_flag field.

The aps_attr_parameter_set_id field provides an identifier for the APS for reference by other syntax elements.

The aps_seq_parameter_set_id field specifies the value of sps_seq_parameter_set_id for the active SPS.

The attr_coding_type field indicates the coding type for the attribute.

According to embodiments, the attr_coding_type field equal to 0 may indicate predicting weight lifting as the coding type. The attr_coding_type field equal to 1 may indicate RAHT as the coding type. The attr_coding_type field equal to 2 may indicate fix weight lifting.

The aps_attr_initial_qp field specifies the initial value of the variable SliceQp for each slice referring to the APS.

The aps_attr_chroma_qp_offset field specifies the offsets to the initial quantization parameter signaled by the syntax aps_attr_initial_qp.

The aps_slice_qp_delta_present_flag field specifies whether the ash_attr_qp_delta_luma and ash_attr_qp_delta_chroma syntax elements are present in the attribute slice header (ASH). For example, the aps_slice_qp_delta_present_flag field equal to 1 specifies that the ash_attr_qp_delta_luma and ash_attr_qp_delta_chroma syntax elements are present in the ASH. For example, the aps_slice_qp_delta_present_flag field specifies that the ash_attr_qp_delta_luma and ash_attr_qp_delta_chroma syntax elements are not present in the ASH.

When the value of the attr_coding_type field is 0 or 2, that is, the coding type is predicting weight lifting or fix weight lifting, the APS according to the embodiments may further include a lifting_num_pred_nearest_neighbours_minus1 field, a lifting_search_range_minus1 field, and a lifting_neighbour_bias[k] field.

lifting_num_pred_nearest_neighbours plus 1 specifies the maximum number of nearest neighbors to be used for prediction. According to embodiments, the value of NumPredNearestNeighbours is set equal to lifting_num_pred_nearest_neighbours.

lifting_search_range_minus1 plus 1 specifies the search range used to determine nearest neighbours to be used for prediction and to build distance-based levels of detail (LODs). The variable LiftingSearchRange for specifying the search range may be obtained by adding 1 to the value of the lifting_search_range_minus1 field (LiftingSearchRange = lifting_search_range_minus1 +1).

The lifting_neighbour_bias[k] field specifies a bias used to weight the k-th components in the calculation of the Euclidean distance between two points as part of the nearest neighbor derivation process.

When the value of the attr_coding_type field is 2, that is, when the coding type indicates fix weight lifting, the APS according to the embodiments may further include a lifting_scalability_enabled_flag field.

The lifting_scalability_enabled_flag field specifies whether the attribute decoding process allows the pruned octree decode result for the input geometry points. For example, the lifting_scalability_enabled_flag field equal to 1 specifies that the attribute decoding process allows the pruned octree decode result for the input geometry points. The lifting_scalability_enabled_flag field equal to 0 specifies that that the attribute decoding process requires the complete octree decode result for the input geometry points.

According to embodiments, when the value of the lifting_scalability_enabled_flag field is FALSE, the APS may further include a lifting_num_detail_levels_minus 1 field.

The lifting_num_detail_levels_minus1 field specifies the number of levels of detail for the attribute coding. The variable LevelDetailCount for specifying the number of LODs may be obtained by adding 1 to the value of the lifting_num_detail_levels_minus1 field. (LevelDetailCount = lifting_num_detail_levels_minus1 + 1).

According to embodiments, when the value of the lifting_num_detail_levels_minus1 field is greater than 1, the APS may further include a lifting_lod_regular_sampling_enabled_flag field.

The lifting_lod_regular_sampling_enabled_flag field specifies whether levels of detail (LODs) are built by a regular sampling strategy. For example, the lifting_lod_regular_sampling_enabled_flag equal to 1 specifies that levels of detail (LOD) are built by using a regular sampling strategy. The lifting_lod_regular_sampling_enabled_flag equal to 0 specifies that a distance-based sampling strategy is used instead.

According to embodiments, when the value of the lifting_scalability_enabled_flag field is FALSE, the APS may further include an iteration statement iterated as many times as the value of the lifting_num_detail_levels_minus 1 field. In an embodiment, the index (idx) is initialized to 0 and incremented by 1 every time the iteration statement is executed, and the iteration statement is iterated until the index (idx) is greater than the value of the lifting_num_detail_levels_minus1 field. This iteration statement may include a lifting_sampling_period_minus2 [idx] field when the value of the lifting_lod_decimation_enabled_flag field is TRUE (e.g., 1), and may include a lifting_sampling_distance_squared_scale_minus1 [idx] field when the value of the lifting_lod_regular_sampling_enabled_flag field is FALSE (e.g., 0). Also, when the value of idx is not 0 (idx != 0), a lifting_sampling_distance_squared_offset [idx] field may be further included.

lifting_sampling_period_minus2 [idx] plus 2 specifies the sampling period for the level of detail idx.

lifting_sampling_distance_squared_scale_minu1 [idx] plus 1 specifies the scale factor for the derivation of the square of the sampling distance for the level of detail idx.

The lifting_sampling_distance_squared_offset [idx] field specifies the offset of the derivation of the square of the sampling distance for the level of detail idx.

When the value of the attr_coding_type field is 0, that is, when the coding type is predicting weight lifting, the APS according to the embodiments may further include a lifting_adaptive_prediction_threshold field, a lifting_intra_lod_prediction_num_layers field, a lifting_max_num_direct_predictors field, and an inter_component_prediction_enabled_flag field.

The lifting_adaptive_prediction_threshold field specifies the threshold to enable adaptive prediction. According to embodiments, a variable AdaptivePredictionThreshold for specifying a threshold for switching an adaptive predictor selection mode is set equal to the value of the lifting_adaptive_prediction_threshold field (AdaptivePredictionThreshold = lifting_adaptive_prediction_threshold).

The lifting_intra_lod_prediction_num_layers field specifies the number of LOD layers where decoded points in the same LOD layer could be referred to generate a prediction value of a target point. For example, the lifting_intra_lod_prediction_num_layers field equal to LevelDetailCount indicates that target point could refer to decoded points in the same LOD layer for all LOD layers. For example, the lifting_intra_lod_prediction_num_layers field equal to 0 indicates that target point could not refer to decoded points in the same LoD layer for any LoD layers. The lifting_max_num_direct_predictors field specifies the maximum number of predictors to be used for direct prediction. The value of the lifting_max_num_direct_predictors field shall be in the range of 0 to LevelDetailCount.

The inter_component_prediction_enabled_flag field specifies whether the primary component of a multi component attribute is used to predict the reconstructed value of non-primary components. For example, when the inter_component_prediction_enabled_flag field equal to 1 specifies that the primary component of a multi component attribute is used to predict the reconstructed value of non-primary components. The inter_component_prediction_enabled_flag field equal to 0 specifies that all attribute components are reconstructed independently.

According to the embodiments, when the value of the attr_coding_type field is 1, that is, when the attribute coding type is RAHT, the APS may further include a raht_prediction_enabled_flag field.

The raht_prediction_enabled_flag field specifies whether the transform weight prediction from the neighbor points is enabled in the RAHT decoding process. For example, the raht_prediction_enabled_flag field equal to 1 specifies the transform weight prediction from the neighbor points is enabled in the RAHT decoding process. raht_prediction_enabled_flag equal to 0 specifies that the transform weight prediction is disabled in the RAHT decoding process.

According to embodiments, when the value of the raht_prediction_enabled_flag field is TRUE, the APS may further include a raht_ prediction_threshold0 field and a raht_prediction_threshold1 field.

The raht_ prediction_threshold0 field specifies a threshold to terminate the transform weight prediction from neighbour points.

The raht_prediction_threshold1 field specifies a threshold to skip the transform weight prediction from neighbour points.

The aps_extension_flag field specifies whether the aps_extension_data_flag syntax structure is present in the APS syntax structure. For example, aps_extension_flag equal to 1 indicates that the aps_extension_data syntax structure is present in the APS syntax structure. For example, aps_extension_flag equal to 0 indicates that the aps_extension_data syntax structure is not present in the APS syntax structure.

When the value of the aps_extension_flag field is 1, the APS according to the embodiments may further include an aps_extension_data_flag field.

The aps_extension_data_flag field may have any value. Its presence and value do not affect decoder conformance to profiles.

The APS according to the embodiments may further include information related to LoD-based attribute compression.

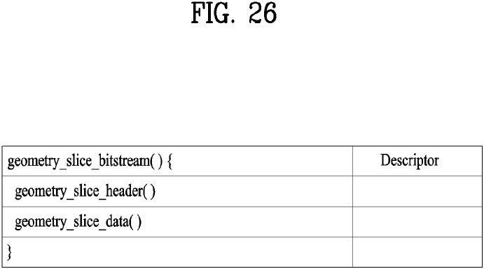

FIG. 26 shows an exemplary syntax structure of geometry_slice_bitstream() according to embodiments.

The geometry slice bitstream (geometry_slice_bitstream()) according to the embodiments may include a geometry slice header (geometry_slice_header()) and geometry slice data (geometry_slice_data()).

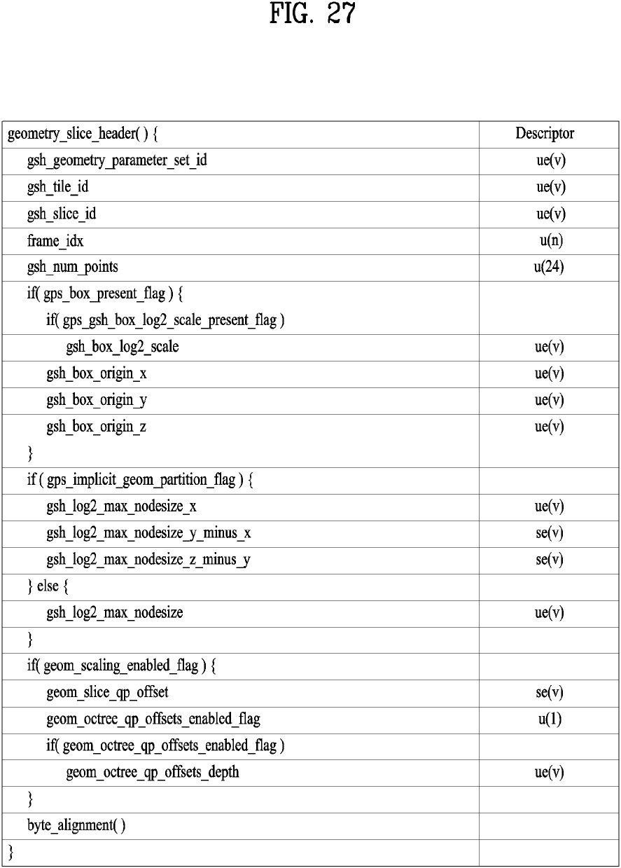

FIG. 27 shows an embodiment of a syntax structure of a geometry slice header (geometry_slice_header()) according to the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

The geometry slice header (geometry_slice_header()) according to the embodiments may include a gsh_geometry_parameter_set_id field, a gsh_tile_id field, gsh_slice_id field, a frame_idx field, a gsh_num_points field, and a byte_alignment() field.

When the value of the gps_box_present_flag field included in the GPS is TRUE (e.g., 1), and the value of the gps_gsh_box_log2_scale_present_flag field is TRUE (e.g., 1), the geometry slice header (geometry _slice_header()) according to the embodiments may further include a gsh_box_log2_scale field, a gsh_box_origin_x field, a gsh_box_origin_y field, and a gsh_box_origin_z field.

gsh_geometry_parameter_set_id specifies the value of the gps_geom_parameter_set_id of the active GPS.

The gsh_tile_id field specifies the value of the tile id that is referenced by the GSH.

The gsh_slice_id specifies ID of the slice for reference by other syntax elements.

The frame_idx field indicates log2_max_frame_idx + 1 least significant bits of a conceptual frame number counter. Consecutive slices with differing values of frame_idx form parts of different output point cloud frames. Consecutive slices with identical values of frame_idx without an intervening frame boundary marker data unit form parts of the same output point cloud frame.

The gsh_num_points field indicates the maximum number of coded points in a slice. According to embodiments, it is a requirement of bitstream conformance that gsh_num_points is greater than or equal to the number of decoded points in the slice.

The gsh_box_log2_scale field specifies the scaling factor of the bounding box origin for the slice.

The gsh_box_origin_x field specifies the x value of the bounding box origin scaled by the value of the gsh_box_log2_scale field.

The gsh_box_origin_y field specifies the y value of the bounding box origin scaled by the value of the gsh_box_log2_scale field.

The gsh_box_origin_z field specifies the z value of the bounding box origin scaled by the value of the gsh_box_log2_scale field.

Here, the variables slice_origin_x, slice_origin_y, and slice_origin_z may be derived as follows.

When gps_gsh_box_log2_scale_present_flag is equal to 0, originScale is set to gsh_box_log2_scale.

When gps_gsh_box_log2_scale_present_flag is equal to 1, originScale is set to gps_gsh_box_log2_scale.

When gps_box_present_flag is equal to 0, the values of the variables slice_origin_x, slice_origin_y, and slice_origin_z are inferred to be 0.

When gps_box_present_flag is equal to 1, the following equations will be applied to the variables slice_origin_x, slice_origin_y, and slice_origin_z.

$$\begin{matrix}\text{slice\_origin\_x} \text{=} \text{gsh\_box\_origin\_x} \text{} \text{<<} \text{originScale} \\ \text{slice\_origin\_y} \text{=} \text{gsh\_box\_origin\_y} \text{} \text{<<} \text{originScale} \\ \text{slice\_origin\_z} \text{=} \text{gsh\_box\_origin\_z} \text{<<} \text{originScale}\end{matrix}$$

When the value of the gps_implicit_geom_partition_flag field is TRUE (i.e., 0), the geometry slice header ((geometry_slice_header())) may further include a gsh_log2_max_nodesize_x field, a gsh_log2_max_nodesize_y_minus_x field, and a gsh_log2_max_nodesize_z_minus_y field. When the value of the gps_implicit_geom_partition_flag field is FALSE (i.e., 1), the geometry slice header may further include a gsh_log2_max_nodesize field.

The gsh_log2_max_nodesize_x field specifies the bounding box size in the x dimension, i.e., MaxNodesizeXLog2 that is used in the decoding process as follows.

$$\begin{matrix}\text{MaxNoodSizeXLog2} \text{=} \text{gsh\_log2\_max\_nodesize\_x} \\ \text{MaxNoodSizeX} \text{=} \text{1} \text{<<} \text{MaxNodeSizeXLog2}\end{matrix}$$

The gsh_log2_max_nodesize_y_minus_x field specifies the bounding box size in the y dimension, i.e., MaxNodesizeYLog2 that is used in the decoding process as follows.

$$\begin{matrix}\text{MaxNodeSizeYLog2=gsh\_log2\_max\_nodesize\_y\_minus\_x} \text{+} \\ \text{MaxNodeSizeXLog2}\end{matrix}$$

$$\text{MaxNodeSizeY} \text{=} \text{1} \text{<<} \text{} \text{MaxNodeSizeYLog2} \text{.}$$

The gsh_log2_max_nodesize_z_minus_y field specifies the bounding box size in the z dimension, i.e., MaxNodesizeZLog2 that is used in the decoding process as follows.

$$\begin{matrix}\text{MaxNodeSizeZLog2=gsh\_log2\_max\_nodesize\_z\_minus\_y} \text{+} \\ \text{MaxNodeSizeYLog2}\end{matrix}$$

$$\text{MaxNodeSizeZ} \text{=} \text{1} \text{<<} \text{} \text{MaxNodeSizeZLog2}$$

When the value of the gps_implicit_geom_partition_flag field is 1, gsh_log2_max_nodesize is obtained as follows.

$$\begin{matrix}\text{gsh\_log2\_max\_nodesize=max} \left\{\text{MaxNodeSizeXLog2,}\right) \\ \text{MaxNodeSizeYLog2,} \\ \left(\text{MaxNodeSizeYLog2}\right\}\end{matrix}$$

The gsh_log2_max_nodesize field specifies the size of the root geometry octree node when gps_implicit_geom_partition_flag is equal to 0.

Here, the variables MaxNodeSize and MaxGeometryOctreeDepth are derived as follows.

$$\begin{matrix}\text{MaxNodeSize} \text{=} \text{1} \text{<<} \text{gsh\_log2\_max\_nodesize} \\ \text{MaxGeometryOctreeDepth+} \\ \text{gsh\_log2\_max\_nodesize-log2\_trisoup\_node\_size}\end{matrix}$$

When the value of the geom_scaling_enabled_flag field is TRUE, the geometry slice header (geometry _slice_header()) according to the embodiments may further include a geom_slice_qp_offset field and a geom_octree_qp_offsets_enabled_flag field.

The geom_slice_qp_offset field specifies an offset to the base geometry quantization parameter geom_base_qp.

The geom_octree_qp_offsets_enabled_flag field specifies whether the geom_octree_qp_ofsets_depth field is present in the geometry slice header. For example, geom_octree_qp_offsets_enabled_flag equal to 1 specifies that the geom_octree_qp_ofsets_depth field is present in the geometry slice header. geom_octree_qp_offsets_enabled_flag equal to 0 specifies that the geom_octree_qp_ofsets_depth field is not present.

The geom_octree_qp_offsets_depth field specifies the depth of the geometry octree.

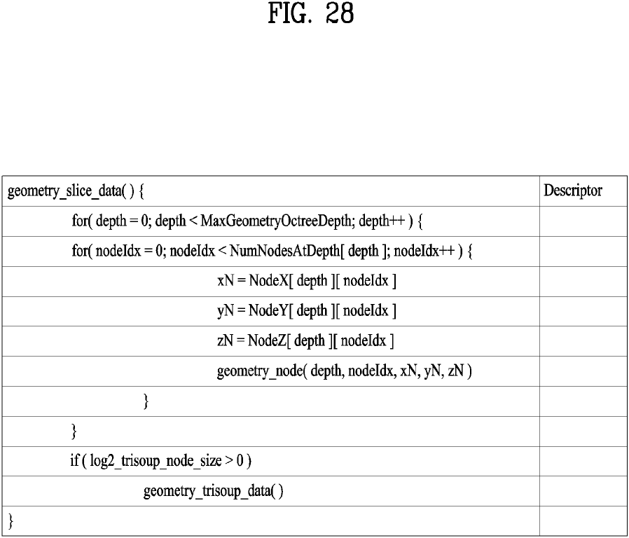

FIG. 28 shows an embodiment of a syntax structure of geometry slice data (geometry_slice_data()) according to the present disclosure. The geometry slice data (geometry_slice_data()) according to the embodiments may carry a geometry bitstream belonging to a corresponding slice.

The geometry_slice_data() according to the embodiments may include a first iteration statement repeated as many times as by the value of MaxGeometryOctreeDepth. In an embodiment, the depth is initialized to 0 and is incremented by 1 each time the iteration statement is executed, and the first iteration statement is repeated until the depth becomes equal to MaxGeometryOctreeDepth. The first iteration statement may include a second loop statement repeated as many times as the value of NumNodesAtDepth. In an embodiment, nodeidx is initialized to 0 and is incremented by 1 each time the iteration statement is executed. The second iteration statement is repeated until nodeidx becomes equal to NumNodesAtDepth. The second iteration statement may include xN = NodeX[depth][nodeIdx], yN = NodeY[depth][nodeIdx], zN = NodeZ[depth][nodeIdx], and geometry_node(depth, nodeIdx, xN, yN, zN). MaxGeometryOctreeDepth indicates the maximum value of the geometry octree depth, and NumNodesAtDepth[depth] indicates the number of nodes to be decoded at the corresponding depth. The variables NodeX[depth][nodeIdx], NodeY[depth][nodeIdx], and NodeZ[depth][nodeIdx] indicate the x, y, z coordinates of the idx-th node in decoding order at a given depth. The geometry bitstream of the node of the depth is transmitted through geometry_node(depth, nodeIdx, xN, yN, zN).

The geometry slice data (geometry_slice_data()) according to the embodiments may further include geometry _trisoup_data() when the value of the log2_trisoup_node_size field is greater than 0. That is, when the size of the triangle nodes is greater than 0, a geometry bitstream subjected to trisoup geometry encoding is transmitted through geometry _trisoup_data().

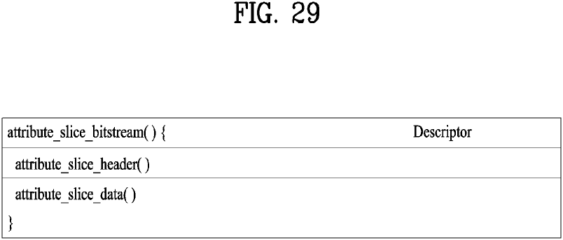

FIG. 29 shows an embodiment of a syntax structure of attribute_slice_bitstream() according to the present disclosure.

The attribute slice bitstream (attribute_slice_bitstream ()) according to the embodiments may include an attribute slice header (attribute_slice_header()) and attribute slice data (attribute_slice_data()).

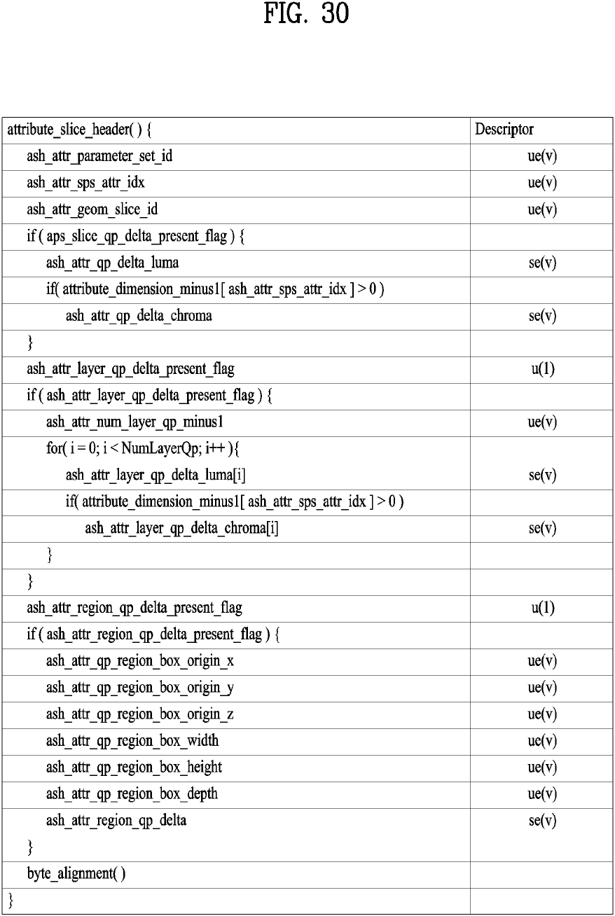

FIG. 30 shows an embodiment of a syntax structure of an attribute slice header (attribute_slice_header()) according to the present disclosure.

The attribute slice header (attribute_slice_header()) according to the embodiments may include an ash_attr_parameter_set_id field, an ash_attr_sps_attr_idx field, an ash_attr_geom_slice_id field, an ash_attr_layer_qp_delta_present_flag field, and an ash_attr_region_qp_delta_present_flag field.

When the value of the aps_slice_qp_delta_present_flag field of the APS is TRUE (e.g., 1), the attribute slice header (attribute_slice_header()) according to the embodiments may further include a ash_attr_qp_delta_luma field. When the value of the attribute_dimension_minus1 [ash_attr_sps_attr_idx] field is greater than 0, the attribute slice header may further include an ash_attr_qp_delta_chroma field.

The ash_attr_parameter_set_id field specifies the value of the aps_attr_parameter_set_id field of the current active APS.

The ash_attr_sps_attr_idx field specifies an attribute set in the current active SPS.

The ash_attr_geom_slice_id field specifies the value of the gsh_slice_id field of the current geometry slice header.

The ash_attr_qp_delta_luma field specifies a luma delta quantization parameter qp derived from the initial slice qp in the active attribute parameter set.

The ash_attr_qp_delta_chroma field specifies the chroma delta qp derived from the initial slice qp in the active attribute parameter set.

The variables InitialSliceQpY and InitialSliceQpC are derived as follows.

$$\begin{matrix}\text{InitialSliceQpY=} \text{aps\_attrattr\_initial\_qp} \text{+} \\ \text{ash\_attr\_qp\_delta\_luma} \\ \text{InitialSliceQpC} \text{=} \text{aps\_attrattr\_initial\_qp} \text{+} \\ \text{aps\_attr\_chroma\_qp\_offset+} \\ \text{ash\_attr\_qp\_delta\_croma}\end{matrix}$$

The ash_attr_layer_qp_delta_present_flag field specifies whether the ash_attr_layer_qp_delta_luma field and the ash_attr_layer_qp_delta_chroma field are present in the ASH for each layer. For example, when the value of the ash_attr_layer_qp_delta_present_flag field is 1, it indicates that the ash_attr_layer_qp_delta_luma field and the ash_attr_layer_qp_delta_chroma field are present in the ASH. When the value is 0, it indicates that the fields are not present.

When the value of the ash_attr_layer_qp_delta_present_flag field is TRUE, the ASH may further include an ash_attr_num_layer_qp_minus1 field.

ash_attr_num_layer_qp_minus1 plus 1 indicates the number of layers through which the ash_attr_qp_delta_luma field and the ash_attr_qp_delta_chroma field are signaled. When the ash_attr_num_layer_qp field is not signaled, the value of the ash_attr_num_layer_qp field will be 0. According to embodiments, NumLayerQp specifying the number of layers may be obtained by adding 1 to the value of the ash_attr_num_layer_qp_minus1 field (NumLayerQp = ash_attr_num_layer_qp_minus1 + 1).

According to embodiments, when the value of the ash_attr_layer_qp_delta_present_flag field is TRUE, the geometry slice header may include a loop iterated as many times as the value of NumLayerQp. In this case, in an embodiment, i may be initialized to 0 and incremented by 1 every time the loop is executed, and the loop is iterated until the value of i reaches the value of NumLayerQp. This loop contains an ash_attr_layer_qp_delta_luma[i] field. Also, when the value of the attribute_dimension_minus1[ash_attr_sps_attr_idx] field is greater than 0, the loop may further include an ash_attr_layer_qp_delta_chroma[i] field.

The ash_attr_layer_qp_delta_luma field indicates a luma delta quantization parameter qp from InitialSliceQpY in each layer.

The ash_attr_layer_qp_delta_chroma field indicates a chroma delta quantization parameter qp from InitialSliceQpC in each layer.

The variables SliceQpY[i] and SliceQpC[i] with i = 0,..., NumLayerQPNumQPLayer-1 are derived as follows.

for (i = 0; i < NumLayerQPNumQPLayer; i++) {
SliceQpY[i] = InitialSliceQpY + ash_attr_layer_qp_delta_luma[i]
SliceQpC[i] = InitialSliceQpC + ash_attr_layer_qp_delta_chroma[i]
}

ash_attr_region_qp_delta_present_flag equal to 1 indicates that ash_attr_region_qp_delta, region bounding box origin, and size are present in the current the attribute slice header (attribute_slice_header()) according to the embodiments. ash_attr_region_qp_delta_present_flag equal to 0 indicates that the ash_attr_region_qp_delta, region bounding box origin, and size are not present in the current attribute slice header.

That is, when the value of the ash_attr_layer_qp_delta_present_flag field is 1, the attribute slice header may further include an ash_attr_qp_region_box_origin_x field, an ash_attr_qp_region_box_origin_y field, an ash_attr_qp_region_box_origin_z field, an ash_attr_qp_region_box_width field, an ash_attr_qp_region_box_height field, an ash_attr_qp_region_box_depth field, and an ash_attr_region_qp_delta field.

The ash_attr_qp_region_box_origin_x field indicates the x offset of the region bounding box relative to slice_origin_x.

The ash_attr_qp_region_box_origin_y field indicates the y offset of the region bounding box relative to slice_origin_y.

The ash_attr_qp_region_box_origin_z field indicates the z offset of the region bounding box relative to slice_origin_z.

The ash_attr_qp_region_box_size_width field indicates the width of the region bounding box.

The ash_attr_qp_region_box_size_height field indicates the height of the region bounding box.

The ash_attr_qp_region_box_size_depth field indicates the depth of the region bounding box.

The ash_attr_region_qp_delta field indicates delta qp from SliceQpY[i] and SliceQpC[i] of a region specified by the ash_attr_qp_region_box field.

According to embodiments, the variable RegionboxDeltaQp specifying a region box delta quantization parameter is set equal to the value of the ash_attr_region_qp_delta field (RegionboxDeltaQp = ash_attr_region_qp_delta).

### The Attribute Slice Header According to Embodiments May Further Include Information Related to LoD-Based Attribute Compression.

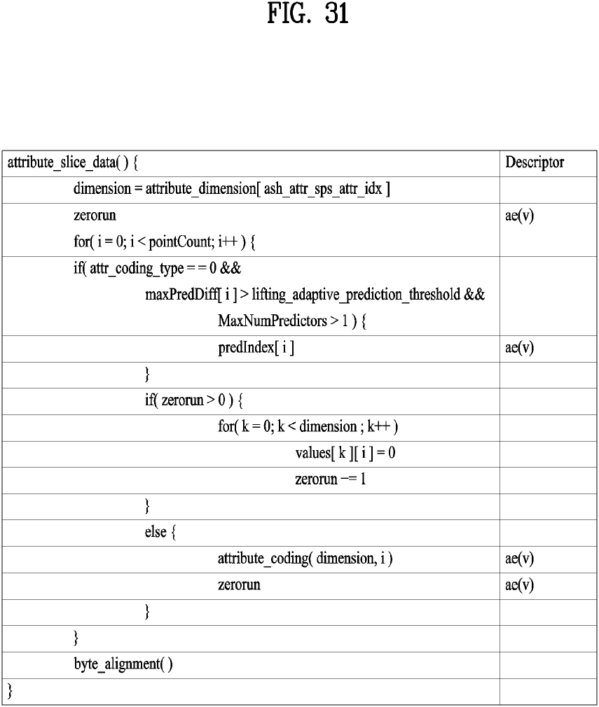

FIG. 31 is a diagram showing an embodiment of a syntax structure of attribute slice data (attribute_slice_data()) according to the present disclosure. The attribute slice data (attribute_slice_data()) according to the embodiments may carry an attribute bitstream belonging to the corresponding slice. The attribute slice data according to the embodiments may include an attribute or attribute related data in relation to some or all of the point clouds.

In FIG. 31, the zerorun field specifies the number of 0 prior to predIndex or residual.

The predIndex[i] field specifies a predictor index for decoding the value of the i-th point of the attribute. The value of the predIndex[i] field ranges from 0 to the value of the max_num_predictors field.

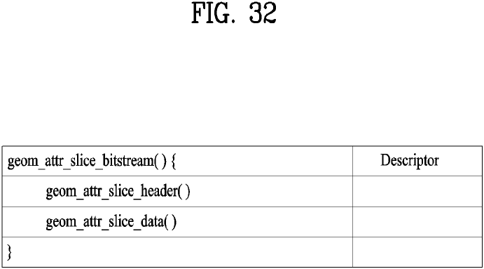

FIG. 32 shows an embodiment of a syntax structure of a geometry-attribute slice bitstream (geom_attr_slice_bitstream()) according to the present disclosure.

geom_attr_slice_bitstream() may include a geometry-attribute slice header (gemo_attr_slice_header()) and geometry-attribute slice data (geom_attr_slice_data()).

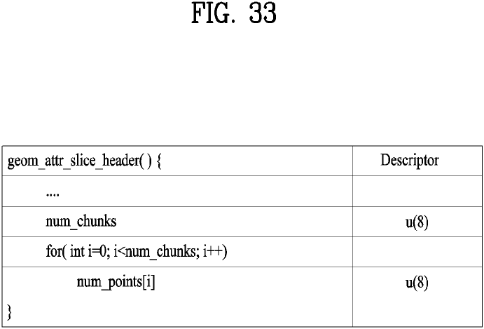

FIG. 33 shows an embodiment of a syntax structure of a geometry-attribute slice header (gemo_attr_slice_header()) according to the present disclosure.

geom_attr_slice_header() may include a num_chunk field, and a num_point field repeated as many times as the value of the num_chunk field.

num_chunk may indicate the number of chunks (i.e., predictive coding units, compression units, or clusters) included in a corresponding slice.

num_point may indicate the number of points included per chunk.

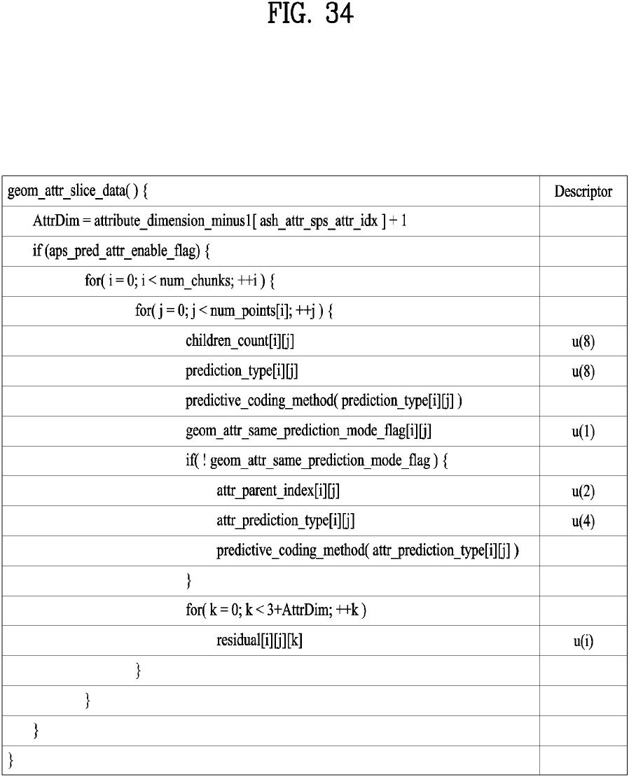

FIG. 34 shows an embodiment of a syntax structure of geometry-attribute slice data (geom_attr_slice_data()) according to the present disclosure. The geom_attr_slice_data()may carry a geometry-attribute bitstream belonging to a corresponding slice.

According to embodiments, when the value of the aps_pred_attr_enable_flag field included in the attribute parameter set or the value of the predictive_coding_per_point_flag field included in the sequence parameter set is 1, the geom_attr_slice_data() may include a first loop iterated as many times as the value of num_chunk, and the first loop includes a second loop iterated as many times as the value of num_point. aps_pred_attr_enable_flag or predictive_coding_per_point_flag may indicate whether the geometry information and the attribute information are simultaneously compressed based on predictive coding.

The second loop may include a children_count[i][j] field, a prediction_type[i][j] field, a predictive_coding_method(prediction_type[i][j]) field, and a geom_attr_same_prediction_mode_flag[i][j] field.

children_count[i][j] may indicate the number of children of the j-th point (i.e., the current point) of the i-th chunk.

prediction_type[i][j] may indicate a prediction method for the attribute information about the j-th point (i.e., the current point) of the i-th chunk. For example, prediction_type set to 0 may indicate a method of delivering the attribute prediction mode. prediction_type set to 1 may indicate prediction prediction_type set to 1 may indicate the average of neighbor points. prediction_type set to 2 may indicate prediction according to the attribute tendency based on multiple parents. prediction_type set to 3 may indicate prediction using coefficients based on a linear relationship with a parent.

The predictive_coding_method(prediction_type[i][j]) may further include additional information related to attribute compression of the j-th point (i.e., the current point) of the i-th chunk according to the value of prediction_type[i][j].

For detailed information included in the predictive_coding_method(prediction_type[i][j]), refer to FIG. 23.

geom_attr_same_prediction_mode_flag[i][j] set to 1 may indicate that the geometry information and the attribute information about the j-th point (i.e., the current point) of the i-th chunk are compressed using the same method. In this case, the same predictive tree and the same predictive coding parameter may be used. geom_attr_same_prediction_mode_flag[i][j] set to 0 may indicate that the same predictive tree and different parameters are used for the geometry information and the attribute information of the j-th point (i.e., the current point) of the i-th chunk.

When the value of the geom_attr_same_prediction_mode_flag[i][j] field is 1, the second loop may further include an attr_parent_index[i][j] field and an attr_prediction_type[i][j] field.

attr_parent_index[i][j] may indicate the position of a separate parent when the attribute information about the j-th point of the i-th chunk is predicted using the separate parent. In this case, the field may indicate a case where a parent different from that for the geometry information is used while the same tree structure is used.

attr_prediction_type [i][j] may indicate a prediction method when the attribute information about the j-th point of the i-th chunk is compressed using a separate predictive coding method.

The second loop may further include predictive_coding_method(attr_prediction_type[i][j]) according to the value of the attr_prediction_type[i][j] field.

The predictive_coding_method(attr_prediction_type[i][j]) may further include additional information related to the attribute compression according to the value of the attr_prediction_type[i][j] field.

According to embodiments, the second loop may further include residual [i][j][k].

residual[i][j][k] may indicate residual information (i.e., prediction error) between the geometry information and the attribute information of the k-th dimension of the j-th point of the i-th chunk.

The operations of the above-described embodiments may be performed through the elements of the point cloud transmission/reception device/method according to the embodiments described below. Each of the elements may correspond to hardware, software, a processor, and/or a combination thereof. Although a method of compressing attribute information related to the point cloud data is described in this embodiment, the method described herein may be applied to geometry information compression and other compression methods.

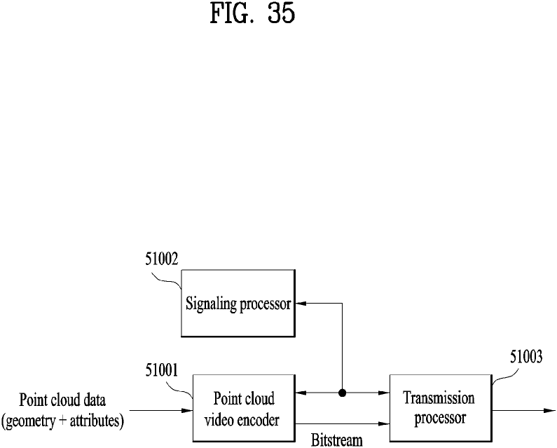

FIG. 35 illustrates another example of a point cloud transmission device according to embodiments. The elements of the point cloud transmission device shown in FIG. 35 may be implemented as hardware, software, a processor, and/or a combination thereof.

According to embodiments, the point cloud transmission device may include a point cloud video encoder 51001, a signaling processor 51002, and a transmission processor 51003.

The point cloud video encoder 51001 may perform some or all of the operations described in relation to the point cloud video encoder 10002 of FIG. 1, the encoding 20001 of FIG. 2, the point cloud video encoder of FIG. 4, and the point cloud video encoder of FIG. 12.

As described above with reference to FIGS. 15 to 18, the point cloud video encoder 51001 may simultaneously compress geometry information and attribute information based on a predictive tree. For details, reference may be made to the description of FIGS. 15 to 18.

The signaling processor 51002 may generate and/or process signaling information necessary to simultaneously compress the geometry information and the attribute information based on the predictive tree, and provide the same to the point cloud video encoder 51001 and/or the transmission processor 51003. Alternatively, the signaling processor 51002 may receive signaling information generated by the point cloud video encoder 51001 and/or the transmission processor 51001. The signaling processor 51002 may provide information (e.g., head orientation information and/or viewport information) fed back from the reception device to the point cloud video encoder 51001 and/or the transmission processor 51003.

In the present disclosure, the signaling information may be signaled and transmitted in a unit of a parameter set (sequence parameter set (SPS), geometry parameter set (GPS), attribute parameter set (APS), tile parameter set (TPS) (or tile inventory), etc.). Alternatvely, it may be signaled and transmitted in a coding unit of each image, such as a slice or a tile.

According to embodiments, the signaling processor 51002 may signal the above-described information related to the point cloud compression in at least the SPS, GPS, TPS, APS, or geometry-attribute slice, and provide the same to the point cloud video encoder 51001 and/or transmission processor 51003. Since the information related to the point cloud compression has been described in detail with reference to FIGS. 22, 23, 33, and 34, a description thereof will be omitted herein.

The method/device according to the embodiments may signal related information to add/perform the operations of the embodiments. The signaling information according to the embodiments may be used by the transmission device and/or the reception device.

The transmission processor 51003 may perform the same or similar operation and/or transmission method as the operation and/or transmission method of the transmission processor 12012 of FIG. 12, and perform the same or similar operation and/or transmission method as the operation and/or transmission method of the transmitter 10003 of FIG. 1. For details, refer to the description of FIG. 1 or FIG. 12. A description thereof will be omitted herein.

The transmission processor 51003 may transmit the geometry-attribute bitstream output from the point cloud video encoder 51001 and the signaling bitstream output from the signaling processor 51002 by multiplexing the bitstreams into one bitstream or or by encapsulating the bitstreams in a file or segment. In an embodiment of the present disclosure, the file may be in the ISOBMFF file format.

According to embodiments, the file or segment may be transmitted to the reception device or stored in a digital storage medium (e.g., USB, SD, CD, DVD, Blu-ray, HDD, SSD, etc.). The transmission processor 51003 is capable of performing wired/wireless communication with the reception device over a network of 4G, 5G, 6G, etc. In addition, the transmission processor 51003 may perform a necessary data processing operation according to the network system (e.g., a 4G, 5G or 6G communication network system). Also, the transmission processor 51003 may transmit the encapsulated data in an on-demand manner.

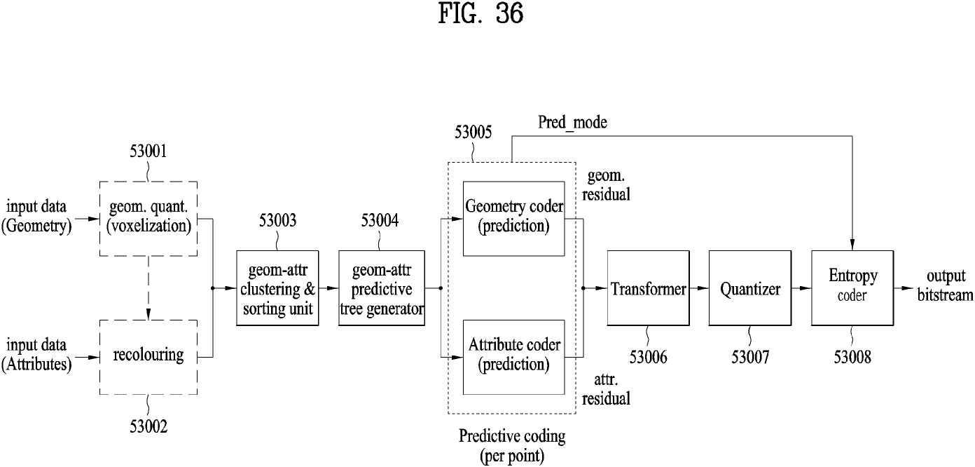

FIG. 36 is an exemplary detailed block diagram of the point cloud video encoder 51001 according to embodiments. The elements of the point cloud video encoder shown in FIG. 36 may be implemented as hardware, software, a processor, and/or a combination thereof.

According to embodiments, the point cloud video encoder 51001 may include a geometry quantizer 53001, a recolorer 53002, a clustering and sorting unit 53003, a predictive tree generator 53004, a compressor 53005, an attribute transformer 53006, a quantizer 53007, and an entropy coder 53008. The clustering and sorting unit 53003 may be divided into a clustering unit and a sorter. The clustering unit may be referred to as a divider. The execution order of the respective blocks may be changed. Some blocks may be omitted, and some blocks may be newly added.

The geometry quantizer 53001 and the recolorer 53002 are optional and may be omitted.

The geometry quantizer 53001 may quantize geometry information. For example, the quantizer 53001 may quantize the points based on the minimum position values (e.g., the minimum values on the X-axis, Y-axis, and Z-axis) of all points. The recolorer 53002 may perform attribute transformation for transforming attributes based on the positions on which geometry encoding has not been performed and/or the reconstructed geometry.

As described in operation 50001 of FIG. 15, the clustering and sorting unit 53003 clusters the points of the input point cloud data based on geometry information and/or attribute information about the points of the input point cloud data and divides the same into multiple compression units (e.g., clusters). Then, as described in operation 50002 of FIG. 15, the points of the point cloud data for each compression unit are sorted in consideration of geometry information and/or attribute information about each point within the compression unit. For more details, refer to the description of FIG. 15.

After the clustering and sorting unit 53003 sorts the points of the point cloud data in each compression unit, the predictive tree generator 53004 may construct a predictive tree within each compression unit. According to embodiments, a predictive tree may be constructed using a method of generating a geometry or attribute predictive tree structure. Accordingly, complexity may be reduced in a low-latency environment because the same structure may be used for compression of geometry information and compression of attribute information in point cloud compression. According to other embodiments, a predictive tree may be constructed considering both the geometry information and the attribute information to be compressed. For details of the generation of the predictive tree, refer to the description of FIG. 15.

Once the predictive tree generator 53004 generates the predictive tree in consideration of the geometry and/or attributes, the compressor 53005 performs prediction for a point to be compressed. For details of the prediction of the points and the acquisition of residual information, refer to the description of FIG. 15.

In this case, geometry information and/or attribute information may be considered according to the purpose of constructing the predictive tree. Such information may be signaled through the predictive_tree_mode field. The predictive_tree_mode field may be carried in at least a sequence parameter set or a geometry-attribute slice. In addition, a prediction method may be determined for a parent and a child whose relationship is defined through the predictive tree, and residual information (i.e., prediction error) may be estimated by the determined method. In this case, by setting the predictive_coding_per_point_flag field to 1, it may be indicated that a method of geometry and attribute-based low-latency point cloud predictive compression is used. In addition, the geom_attr_same_prediction_mode_flag field may be used to indicate whether the same prediction mode is used for the geometry information and the attribute information. The method used for the prediction may be indicated by the prediction_type field. A pred_mode field, a coeff_a field, a coeff_b field, a num_neighbors field, a num_parents_minus1 field, a point_index field, and a num_same_coeff_pred_points field may be delivered to the reception device as related signals according to the value of the prediction_type field.

The predictive_tree_modefield, predictive_coding_per_point_flag field, geom_attr_same_prediction_mode_flagfield, prediction_type field, pred_mode field, coeff_a field, coeff_b field, num_neighbors field, num_parents_minus1 field, point_index field, and num_same_coeff_pred_points field are referred to as information related to point cloud compression. Alternatively, the information related to point cloud compression may include the above-mentioned fields. Since the above fields have been described in detail with reference to FIGS. 22, 23, 33, and 34, a description thereof will be omitted.

The prediction mode (pred_mode) selected by the compressor 53005 may be included in the predictive_coding_method of FIG. 23 and transmitted to the reception device. The predictive_coding_method may be included in at least one of SPS, APS, GPS, TPS, or a geometry-attribute slice.

The prediction error (or residual information) related to the geometry information and the attribute information acquired by the compressor 53005 is transformed into the compression domain by the attribute transformer 53006 and then quantized by the quantizer 53007. In the case where the quantization is performed, an error that may occur in the reception device may be reduced by updating the quantized value when the prediction is performed. Since the update of the quantized value has been described in detail above, a description thereof will be omitted. The quantized residual information is entropy-coded by the entropy coder 53008 and output in the form of a geometry-attribute bitstream.

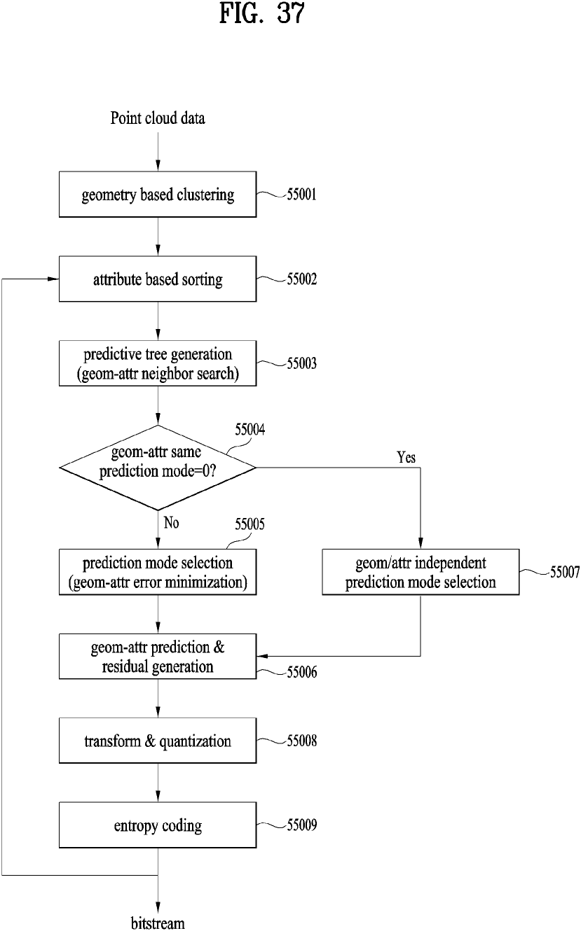

FIG. 37 is a flowchart illustrating an example of a method of compressing geometry information and attribute information based on a predictive tree according to embodiments.

According to embodiments, a clustering operation of grouping points with high relevance is performed on input point cloud data (operation 55001). When the clustering is performed in operation 55001, the points of the input point cloud data are divided into a plurality of clusters (i.e., compression units or chunks). For details, refer to the description of FIG. 15.

Then, for each compression unit, the points of the point cloud data are sorted in consideration of the geometry information and/or attribute information about each point within the compression unit (operation 55002). For details, refer to the description of FIG. 15.

According to embodiments, in operation 55001, related points may be bundled based on geometry similarity, and each bundle may be configured as a chunk (or referred to as a compression unit or a prediction unit). In operation 55002, the points of the point cloud data in the compression unit are sorted based on attribute similarity. That is, by sorting the point cloud data clustered based on the geometry based on the attribute, the geometry similarity and the attribute similarity are considered together. Accordingly, the compression efficiency of the geometry information and the attribute information may be increased.

Once the points of the point cloud data in the compression unit (or chunk) are sorted in operation 55002, a predictive tree structure is constructed based on the sorted points (operation 55003). According to embodiments, a predictive tree may be constructed using a method of generating a geometry or attribute predictive tree structure. Accordingly, complexity may be reduced in a low-latency environment because the same structure may be used for compression of geometry information and compression of attribute information in point cloud compression. According to other embodiments, a predictive tree may be constructed considering the geometry information and the attribute information together between a parent and a child. Accordingly, the geometry and attribute compression efficiency may be increased even when a single predictive tree is used.

Once the predictive tree structure is constructed in operation 55003, it is checked whether prediction mode indication information (geom_attr_same_prediction_mode_flag) for indicating whether the geometry information and the attribute information are compressed using the same method is set to 1 (operation 55004). For example, geom_attr_same_prediction_mode_flag set to 1 may indicate that the geometry information and the attribute information use the same predictive tree and the same predictive coding parameter. geom_attr_same_prediction_mode_flag set to 0 may indicate that the geometry information and the attribute information use the same predictive tree while using different prediction coding parameters.

When it is determined in operation 55004 that geom_attr_same_prediction_mode_flag is 1, the process proceeds to operation 55005 and a prediction mode that minimizes an error is selected in consideration of the geometry and attribute information.

When it is determined in operation 55004 that geom_attr_same_prediction_mode_flag is 0, the process proceeds to operation 55007 and a prediction mode that independently minimizes the error is selected for the geometry and the attributes.

Residual information (i.e., prediction error) is acquired for the geometry and the attributes based on the prediction mode selected in operation 55005 or operation 55007 (operation 55006).

The residual information (i.e., prediction error) related to the geometry information and attribute information acquired in operation 55006 is transformed into a compression domain and then quantized (operation 55008). In the case where the quantization is performed, an error that may occur in the reception device may be reduced by updating the quantized value when the prediction is performed. Since the update of the quantized value has been described in detail above, a description thereof will be omitted. The quantized residual information is entropy-coded and output in the form of a geometry-attribute bitstream (operation 55009).

For parts of FIG. 37 which are not described, refer to the description of FIG. 15.

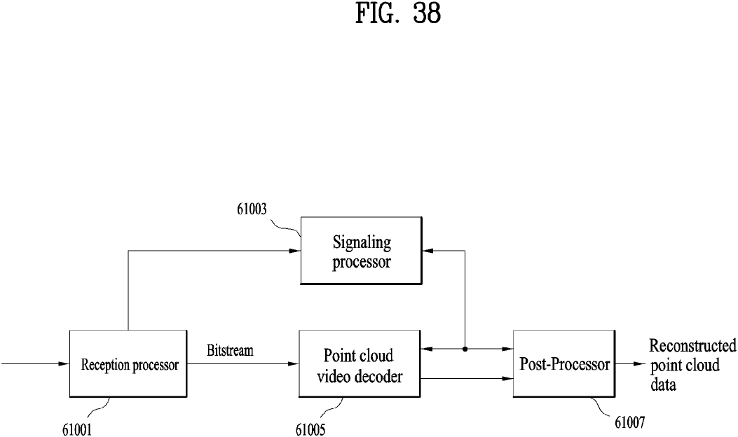

FIG. 38 is a diagram illustrating another example of a point cloud reception device according to embodiments. The elements of the point cloud reception device shown in FIG. 38 may be implemented as hardware, software, a processor, and/or a combination thereof.

According to embodiments, a point cloud reception device may include a reception processor 61001, a signaling processor 61003, a point cloud video decoder 61005, and a post-processor 61005.

The reception processor 61001 may receive one bitstream, or may receive a geometry-attribute bitstream and a signaling bitstream, respectively. Upon receiving a file and/or segment, the reception processor 61001 may decapsulate the received file and/or segment and output a bitstream.

When one bitstream is received (or decapsulated), the reception processor 61001 may demultiplex a geometry-attribute bitstream and a signaling bitstream from the one bitstream, and output the demultiplexed signaling bitstream to the signaling processor 61003 and the geometry-attribute bitstream to the point cloud video decoder 61005.

When the geometry-attribute bitstream and the signaling bitstream are received (or decapsulated), respectively, the reception processor 61001 may transmit the signaling bitstream to the signaling processor 61003, and the geometry-attribute bitstream to the point cloud video decoder 61005.

The signaling processor 61003 may parse and process information included in signaling information, for example, SPS, GPS, APS, TPS, metadata, or the like, from the input signaling bitstream, and may provide the same to the point cloud video decoder 61005 and/or the post-processor 61007. In another embodiment, the signaling information included in the geometry-attribute slice header may also be parsed by the signaling processor 61003 before the corresponding slice data is decoded.

According to embodiments, the signaling processor 61003 may also parse and process at least information related to point cloud compression signaled in the SPS, GPS, APS, TPS, or geometry-attribute slice and provide the same to the point cloud video decoder 61005 and/or the post-processor 61007.

According to embodiments, the point cloud video decoder 61005 may perform the reverse process of the operation of the point cloud video encoder 51001 of FIG. 35 for the compressed geometry-attribute bitstream based on the signaling information to reconstruct geometry and attributes. The point cloud video decoder 61005 may perform some or all of the operations described in relation to the point cloud video decoder of FIG. 1, the decoding of FIG. 2, the point cloud video decoder of FIG. 11, and the point cloud video decoder of FIG. 13.

According to embodiments, the post-processor 61007 may reconstruct and display/render the point cloud data based on the geometry information (i.e., positions) and attribute information that are reconstructed and output by the point cloud video decoder 61005.

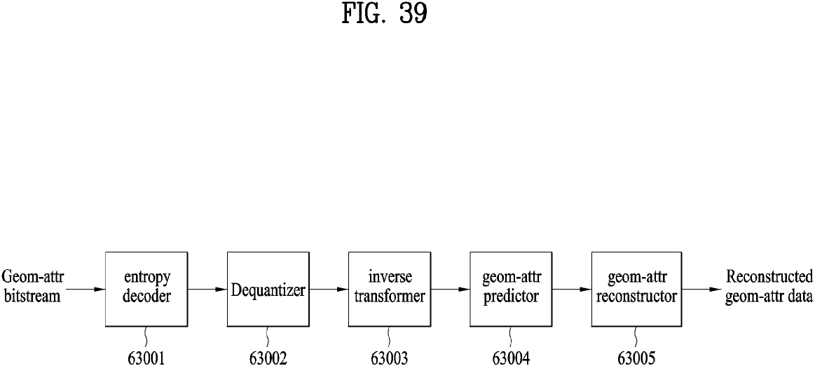

FIG. 39 is an exemplary detailed block diagram illustrating the point cloud video decoder 61005 according to embodiments. The elements of the attribute decoder shown in FIG. 39 may be implemented as hardware, software, a processor, and/or a combination thereof.

According to embodiments, the point cloud video decoder 61005 may include an entropy decoder 63001, a dequantizer 63002, an inverse transformer 63003, a predictor 63004, and a reconstructor 63005. The order of execution of the respective blocks may be changed. Some blocks may be omitted, and some blocks may be newly added.

According to embodiments, the point cloud video decoder 61005 reconstructs the geometry information and the attribute information through the reverse process of the operation of the point cloud video encoder 51001 of the transmission device. That is, the entropy decoder 63001 entropy-decodes residual information (i.e., prediction error) related to the geometry and attribute information contained in the bitstream input through the reception processor 61001. The entropy-decoded residual information is dequantized by the dequantizer 63002, and is output to the predictor 63004 after the reverse process of the operation of the attribute transformer 53006 is performed by the inverse transformer 63003.

The predictor 63004 identifies the predictive tree structure according to the signaling information and/or the parent_index field or point order included in the corresponding slice, and performs prediction based on information related to point cloud compression, such as the pred_mode field and prediction_type to output the predicted information. Then, the reconstructor 63005 reconstructs the geometry information and the attribute information based on the predicted information and the restored residual information. In this case, the predictor 63004 skips the operation of a prediction group (or prediction unit) information generation as the same predictive tree is used for both the geometry information and the attribute information. Accordingly, the execution time for the prediction and reconstruction may be greatly reduced. In particular, the low-latency effect may be significant as the same tree structure as that for the geometry prediction is used for the attribute prediction.

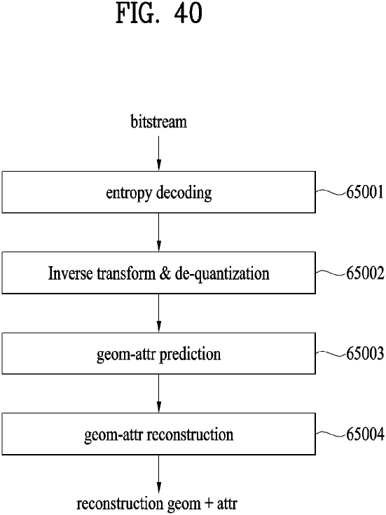

FIG. 40 is a flowchart illustrating an example of a method of reconstructing geometry information and attribute information based on a predictive tree according to embodiments.

According to embodiments, residual information (i.e., prediction error) related to geometry and attribute information contained in in an input bitstream is entropy-decoded (operation 65001). Dequantization and inverse transformation are performed on the entropy-decoded residual information to restore residual information (i.e., prediction error) related to each point (operation 65002).

Then, the predictive tree structure is identified according to the signaling information and/or the parent_index field or point order included in the corresponding slice, and prediction is performed based on information related to point cloud compression, such as the pred_mode field and prediction_type, to output the predicted information (operation 65003). According to embodiments, in operation 65003, the parent of the current point may be searched for based on the signaling information and/or the information related to point cloud compression signaled in the slice and a correlated data search method. In this case, when the predictive_coding_per_point_flag field is set to 1, it may indicate that the predictive tree is used for both the geometry and the attributes and that the geometry and the attribute may be reconstructed for every point. Then, based on the received prediction method, predicted information is searched using the parent and related points. Then, points are reconstructed by reconstructing the geometry information and attribute information based on the predicted information and the restored residual information (operation 65004).

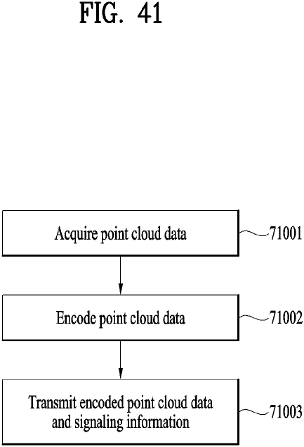

FIG. 41 is a flowchart illustrating a point cloud data transmission method according to embodiments.

The point cloud data transmission method according to the embodiments may include acquiring point cloud data (71001), encoding the point cloud data (71002), and transmitting the encoded point cloud data and signaling information (71003). In this case, a bitstream containing the encoded point cloud data and the signaling information may be encapsulated into a file and transmitted.

In operation 71001 of acquiring the point cloud data, a part or all of the operations of the point cloud video acquisition unit 10001 of FIG. 1 may be performed, or a part or all of the operations of the data input unit 12000 of FIG. 12 may be performed.

In operation 71002 of encoding the point cloud data, some or all of the operations of the point cloud video encoder 10002 of FIG. 1, the encoding 20001 of FIG. 2, the point cloud video encoder of FIG. 4, the point cloud video encoder of FIG. 12, the point cloud video encoder of FIG. 35 may be performed.

In operation 71002 of encoding the point cloud data, geometry information and attribute information may be simultaneously compressed based on a predictive tree as described above with reference to FIGS. 15 to 18 and 35 to 37. For details, refer to the descriptions of FIGS. 15 to 18 and 35 to 37.

In the present disclosure, the signaling information may be SPS, GPS, APS, TPS, metadata, or the like, and the geometry-attribute slice header may also be referred to as signaling information. Information related to point cloud compression may be signaled in at least one of the SPS, the GPS, the APS, the TPS, or a geometry-attribute slice. Since the information related to the point cloud compression has been described in detail above, a description thereof will be omitted.

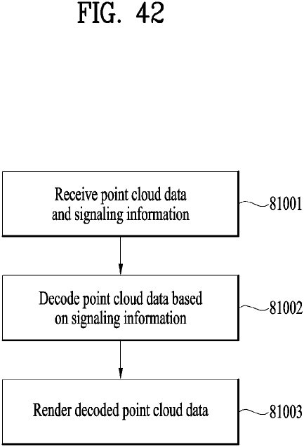

FIG. 42 is a flowchart illustrating a point cloud data reception method according to embodiments.

The point cloud data reception method according to the embodiments may include receiving encoded point cloud data and signaling information (81001), decoding the point cloud data based on the signaling information (81002), and rendering the decoded point cloud data (81003).

Operation 81001 of receiving the point cloud data and the signaling information may be performed by the receiver 10005 of FIG. 1, the transmission 20002 or decoding 20003 of FIG. 2, the receiver 13000 of FIG. 13 or the reception processor 13001.

The signaling information may be SPS, GPS, APS, TPS, metadata, or the like, and the geometry-attribute slice header may also be referred to as signaling information. At least one of the SPS, the GPS, the APS, the TPS, or a geometry-attribute slice may include information related to point cloud compression. Since the information related to the point cloud compression has been described in detail above, a description thereof will be omitted.

In operation 81002 of decoding the point cloud data, some or all of the operations of the point cloud video decoder 10006 of FIG. 1, the decoding 20003 of FIG. 2, the point cloud video decoder of FIG. 11, the point cloud video decoder of FIG. 13, and the point cloud video decoder 61005 of FIG. 38 may be performed.

In operation 81002 of decoding the point cloud data, geometry information and attribute information may be simultaneously reconstructed based on a predictive tree as described above with reference to FIGS. 15 to 18 and 38 to 40. For details, refer to the descriptions of FIGS. 15 to 18 and 38 to 40.

In the rendering 81003, the point cloud data may be reconstructed based on the restored (or reconstructed) geometry information and attribute information and rendered according to various rendering methods. For example, the points of the point cloud content may be rendered as a vertex having a certain thickness, a cube having a specific minimum size centered at a vertex position, or a circle centered at the vertex position. All or part of the regions of the rendered point cloud content is provided to the user through a display (e.g., VR/AR display, general display, etc.). Operation 81003 of rendering the point cloud data may be performed by the renderer 10007 of FIG. 1, the rendering 20004 of FIG. 2, or the renderer 13011 of FIG. 13.

The point cloud data transmission method and transmission device according to the embodiments may efficiently compress and signal the point cloud data within a short time based on the predictive coding operation according to the above-described embodiments and transmit the same to the reception device. Similarly, the reception method and the reception device according to the embodiments may efficiently reconstruct geometry data and/or attribute data based on the signaling information.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “...module (or unit)” disclosed in the specification means a unit for processing at least one function or operation, and may be implemented by hardware, software or combination of hardware and software.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The devices and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion. In the present disclosure, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.”

Further, in the document, the term “or” should be interpreted as “and/or.” For instance, the expression “A or B” may mean 1) only A, 2) only B, and/or 3) both A and B. In other words, the term “or” in the present disclosure should be interpreted as “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

### MODE FOR DISCLOSURE

As described above, related contents have been described in the best mode for carrying out the embodiments.

### INDUSTRIAL APPLICABILITY

As described above, the embodiments may be fully or partially applied to the point cloud data transmission/reception device and system. It will be apparent to those skilled in the art that variously changes or modifications may be made to the embodiments within the scope of the embodiments. Thus, it is intended that the embodiments cover the modifications and variations of this disclosure provided they come within the scope of the appended claims and their equivalents.

1. A method of transmitting point cloud data, the method comprising:
encoding point cloud data; and
transmitting the encoded point cloud data and signaling data,
wherein the encoding comprises:
dividing the point cloud data into a plurality of compression units;
sorting the point cloud data in each of the compression units according to the compression units;
generating a predictive tree based on the sorted point cloud data in each of the compression units; and
compressing the point cloud data in the compression units by performing prediction based on the predictive tree.

2. The method of claim 1, wherein the dividing comprises:
clustering the point cloud data based on at least one of similarity of geometry information or similarity of attribute information related to points of the point cloud data; and
dividing points of the point cloud data into the plurality of compression units.

3. The method of claim 1, wherein the sorting comprises:
sorting points of the point cloud data in each of the compression units based on at least one of similarity of geometry information or similarity of attribute information related to the points of the point cloud data in each of the compression units.

4. The method of claim 1, wherein the generating of the predictive tree comprises:
generating the predictive tree based on at least one of similarity of geometry information or similarity of attribute information related to points of the sorted point cloud data in each of the compression units.

5. The method of claim 4, wherein the compressing comprises:
predicting the geometry information and the attribute information related to the point cloud data based on the predictive tree and generating residual information related to the geometry information and residual information related to the attribute information,
wherein different weights are assigned to the residual information related to the geometry information and the residual information related to the attribute information.

6. The method of claim 5, wherein, in the predicting of the geometry information and attribute information related to the point cloud data based on the predictive tree, the compressing applies the same predictive coding parameter to the geometry information and the attribute information.

7. The method of claim 5, wherein, in the predicting of the geometry information and attribute information related to the point cloud data based on the predictive tree, the compressing applies different predictive coding parameters to the geometry information and the attribute information.

8. A device for transmitting point cloud data, the device comprising:
an encoder configured to encode point cloud data; and
a transmitter configured to transmit the encoded point cloud data and signaling data,
wherein the encoder comprises:
a divider configured to divide the point cloud data into a plurality of compression units;
a sorter configured to sort the point cloud data in each of the compression units according to the compression units;
a predictive tree generator configured to generate a predictive tree based on the sorted point cloud data in each of the compression units; and
a compressor configured to compress the point cloud data in the compression units by performing prediction based on the predictive tree.

9. The device of claim 8, wherein the divider is configured to:
cluster the point cloud data based on at least one of similarity of geometry information or similarity of attribute information related to points of the point cloud data to divide the points of the point cloud data into the compression units; and
divide points of the point cloud data into the plurality of compression units.

10. The device of claim 8, wherein the sorter sorts points of the point cloud data in each of the compression units based on at least one of similarity of geometry information or similarity of attribute information related to the points of the point cloud data in each of the compression units.

11. The device of claim 8, wherein the predictive tree generator generates the predictive tree based on at least one of similarity of geometry information or similarity of attribute information related to points of the sorted point cloud data in each of the compression units.

12. The device of claim 11, wherein the compressor predicts the geometry information and the attribute information related to the point cloud data based on the predictive tree and generates residual information related to the geometry information and residual information related to the attribute information,
wherein different weights are assigned to the residual information related to the geometry information and the residual information related to the attribute information.

13. The device of claim 12, wherein, in predicting the geometry information and attribute information related to the point cloud data based on the predictive tree, the compressor applies the same predictive coding parameter to the geometry information and the attribute information.

14. The device of claim 12, wherein, in predicting the geometry information and attribute information related to the point cloud data based on the predictive tree, the compressor applies different predictive coding parameters to the geometry information and the attribute information.

15. A method of receiving point cloud data, the method comprising:
receiving point cloud data and signaling data;
decoding the point cloud data based on the signaling data; and
rendering the decoded point cloud data based on the signaling data,
wherein the decoding comprises:
generating a predictive tree in a compression unit based on the signaling data; and
reconstructing the point cloud data in the compression unit by performing prediction based on the predictive tree.

16. The method of claim 15, wherein the reconstructing comprises:
performing the prediction by applying the predictive tree and the same predictive coding parameter to geometry information and attribute information related to the point cloud data; and
reconstructing the geometry information and the attribute information.

17. The method of claim 15, wherein the reconstructing comprises:
performing the prediction by applying the predictive tree and different predictive coding parameters to geometry information and attribute information related to the point cloud data; and
reconstructing the geometry information and the attribute information.

18. A device for receiving point cloud data, the device comprising:
a receiver configured to receive point cloud data and signaling data;
a decoder configured to decode the point cloud data based on the signaling data; and
a renderer configured to render the decoded point cloud data based on the signaling data,
wherein the decoder comprises:
a predictive tree generator configured to generate a predictive tree in a compression unit based on the signaling data, and
a reconstructor configured to reconstruct the point cloud data in the compression unit by performing prediction based on the predictive tree.

19. The device of claim 18, wherein the reconstructor is configured to:
perform the prediction by applying the predictive tree and the same predictive coding parameter to geometry information and attribute information related to the point cloud data; and
reconstruct the geometry information and the attribute information.

20. The device of claim 18, wherein the reconstructor is configured to:
perform the prediction by applying the predictive tree and different predictive coding parameters to geometry information and attribute information related to the point cloud data; and
reconstruct the geometry information and the attribute information.
